(19) United States
(12) Patent Application Publication
(10) Pub. No.: US 2002/0177955 A1
(43) Pub. Date: Nov. 28, 2002

(54) Completions architecture

(76) Inventors: Younes Jalali, Sugar Land, TX (US); Shekhar Sinha, Cambridge (GB); Allyson Gajraj, Katy, TX (US); Soraya S. Betancourt, Ridgefield, CT (US); Rintu Kalita, Cambridge (GB); David L. Malone, Sugar Land, TX (US)

Correspondence Address: Schlumberger Technology Corporation, 14910 Airline Road, P.O. Box 1590, Rosharon, TX, 77583-1590, US

(21) Appl. No.: 10/085,808

(22) Filed: Feb. 28, 2002

Related U.S. Application Data
(63) Continuation-in-part of application No. 09/952,178, filed on Sep. 12, 2001.
(60) Provisional application No. 60/236,125, filed on Sep. 28, 2000.
(60) Provisional application No. 60/236,905, filed on Sep. 28, 2000.
(60) Provisional application No. 60/237,083, filed on Sep. 28, 2000.
(60) Provisional application No. 60/237,084, filed on Sep. 28, 2000.

(51) Int. Cl. G01V 3/00

(52) U.S. Cl. 702/9; 166/255.2; 175/45; 340/853.1

(57) ABSTRACT

A method and apparatus for performing well planning and design includes performing a general-level design. The general-level design involves generating a proposed well configuration based on inputs from a user. The proposed configuration, generated by a software module, includes a well trajectory, the reservoir-wellbore interface, and completion equipment. The proposed configuration is refined by an optimizer based on a performance measure or a target constraint.

### CROSS-REFERENCE TO RELATED APPLICATIONS

This is a continuation-in-part of U.S. Ser. No. 09/952,178, filed Sep. 12, 2001, which claims the benefit under 35 U.S.C. §119(e) of U.S. Provisional Applications having Serial Nos. 60/236,125, filed Sep. 28, 2000; 60/236,905, filed Sep. 28, 2000; 60/237,083, filed Sep. 28, 2000; and 60/237,084, filed Sep. 28, 2000.

### TECHNICAL FIELD

The present invention generally relates to well planning and design.

### BACKGROUND

There are many different types of wells, which may require different completion designs for efficient operation, improved production, and extended life. For example, a well may have several possible trajectories, including vertical, deviated, or horizontal. The type of interface between a reservoir and a wellbore can also vary (e.g., open hole, cased hole, etc.). In addition, the type of equipment used in a wellbore impacts the performance of the wellbore. As examples, such equipment includes control devices (such as valves that can be used for actuating the flow from one or more formations), sensors, gauges, or other monitoring devices to detect various well conditions (e.g., temperature, pressure, formation characteristics, etc.), packers for use in isolating different segments of the well completion, pumps, sand control equipment, water control equipment, artificial lift systems, and other equipment.

With the wide variety of available completion equipment and with the many different types of wells (e.g., vertical wells, deviated wells, horizontal wells, multilateral wells, etc.), it is often difficult to accurately determine a well configuration that optimizes production from the reservoir. Typically, the conventional well design methodology is an art without consistency.

As a result, after a well has been selected and completion equipment has been installed in the well, a well operator may find that the selected well and/or completion equipment does not provide the desired or expected level of production at target costs. Therefore, a need continues to exist for a consistent methodology for providing accurate well design.

### SUMMARY

In general, a consistent methodology and apparatus is provided to determine a configuration for a well using a combined knowledge-based and optimization-based approach. For example, a method of determining the well configuration includes receiving, at a first module executable in a system, input data relating to characteristics of a reservoir and a well surface arrangement. Based on the input data, the first module selects a trajectory of a wellbore in the reservoir, a type of interface between the reservoir and the wellbore, and completion equipment for installation in the wellbore.

Other or alternative features will become apparent from the following description, from the drawings, and from the claims.

### BRIEF DESCRIPTION OF THE DRAWINGS

FIG. 1 is a representation of example oil fields and wells drilled in corresponding fields.

FIG. 2 is a flow diagram of a well planning and design process, in accordance with an embodiment, including a general-level design phase, a detailed design phase, and an operation phase.

FIG. 3 is a block diagram of a completions architect tool that is executable in a computer system to select a well configuration, with the completions architect tool including a completions configurator and a completions optimizer.

FIGS. 4-6 are flow diagrams of logic performed by the completions configurator of FIG. 3 in selecting a well trajectory based on input data.

FIG. 7 is a flow diagram of logic performed by the completions configurator of FIG. 3 in selecting whether the well is to be a multilateral well.

FIGS. 8-9 are flow diagrams of logic performed by the completions configurator of FIG. 3 in selecting a reservoir-wellbore interface.

FIG. 10 is a flow diagram of logic performed by the completions configurator of FIG. 3 in selecting a lower completion design for a well.

FIGS. 11A-11B, 12, and 13 are flow diagrams of logic performed by the completions configurator of FIG. 3 in selecting an upper completion design for the well.

FIG. 14 is a flow diagram of logic performed by the completions optimizer of FIG. 3.

FIG. 15 is a flow diagram of the design phase of FIG. 2.

FIG. 16 illustrates an example completion system that can be designed in the design phase of FIG. 15.

FIG. 17 is a graph of valve choke positions and valve flow areas to illustrate several possible designs of a valve in the completion system of FIG. 16.

FIG. 18 illustrates the operation phase of FIG. 2.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

As used here, the terms “up” and “down”; “upper” and “lower”; “upwardly” and downwardly”; “upstream” and “downstream”; and other like terms indicating relative positions above or below a given point or element are used in this description to more clearly describe some embodiments of the invention. However, when applied to equipment and methods for use in wells that are deviated or horizontal, such terms may refer to a left to right, right to left, or other relationship as appropriate.

According to some embodiments of the invention, a consistent methodology is provided in performing well designs to screen alternative well completion configurations for a wide spectrum of reservoir and field conditions. A completion configuration includes a well trajectory in the pay zone, reservoir-wellbore interface, and well completion equipment (including lower completion and upper completion). In some embodiments, the design methodology includes a knowledge-based and optimization-based approach, which takes into account multi-disciplinary considerations (including disciplines such as drilling, geomechanics, production, reservoir, operations, and completions technology). Knowledge regarding completions technology (e.g., multilateral technology, sand control technology, flow control technology, artificial lift technology, permanent monitoring technology, etc.) evolves with the evolution of technology as captured in an information database that can be updated. Also, economics considerations are at least implicitly incorporated into decision rules so that design decisions are rational from an economics viewpoint.

The optimization-based approach provided by some embodiments of the invention is superior to conventional trial-and-error and heuristic approaches. The optimization-based approach can be employed during either the pre-drilling or post-drilling phases of operation. During the pre-drilling phase, optimization leads to definition of a completion of required adaptability, which is proportional to the degree of uncertainty associated with the reservoir. The pre-drilling phase includes determining a configuration that is suitable for the reservoir, field condition, and operator objectives. Completion design in mature fields or fields with an extensive production history relies largely on past experience, which dictates the conceptual design and detailed analysis to determine the final design. In new developments and in fields undergoing development drilling, there is uncertainty associated with the large-scale characteristics and trends of the reservoir, and hence the conceptual design should allow for some degree of flexibility and adaptation.

During the post-drilling phase, optimization leads to the modification, adjustment, and fine tuning of the completion. Logging-while-drilling measurements provide a basis for post-drilling completion optimization.

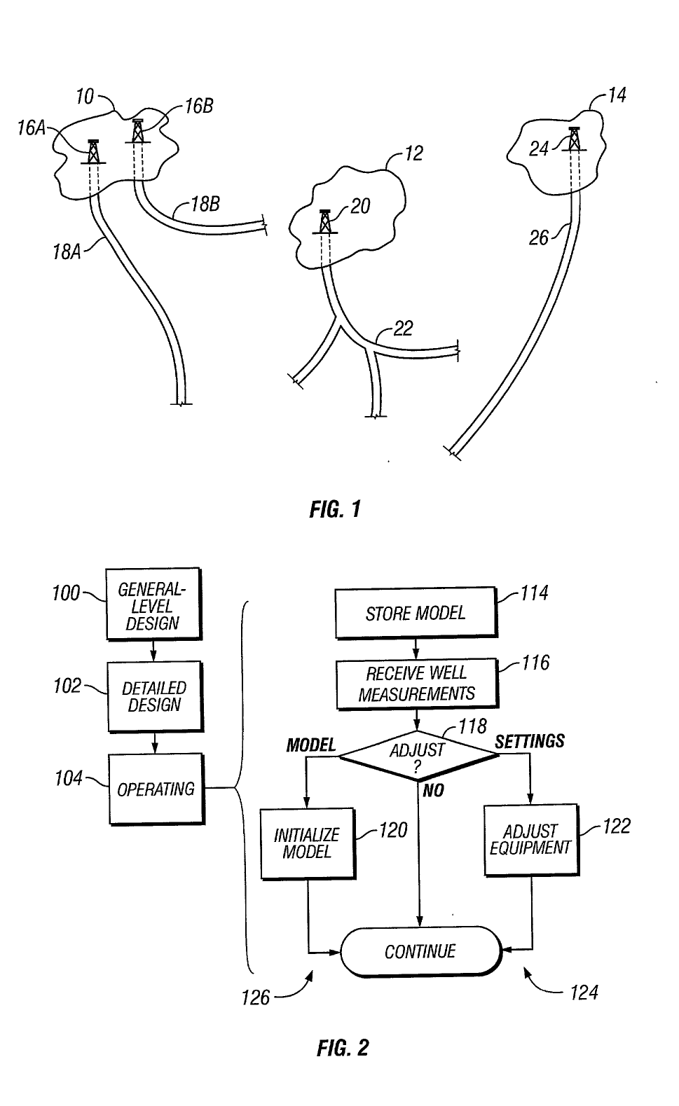

According to one example, FIG. 1 shows several oil fields 10, 12, 14, in which wells 18A, 18B, 22, and 26 have been drilled. The wells 18A, 18B, 22, 26 may be exploration wells that are used for collecting information regarding characteristics of reservoirs through which each well passes. Such information can be collected using various logging techniques. Each of the wells 18A, 18B, 22, and 26 extends from respective wellhead equipment 16A, 16B, 20, and 24.

In accordance with some embodiments, information collected about each of the wells 18A, 18B, 22, and 26 can be used by some embodiments of the invention for purposes of well planning and design. Well planning and design may involve several phases, including high-level design, detailed design, and operation.

As shown in FIG. 2, the general-level design is performed (at 100) to define an overall configuration of the well completion system without going into specific aspects of various components of the completion system. For example, the general-level design can determine the well trajectory (e.g., slant, horizontal, vertical, etc.) and the general reservoir-wellbore interface (e.g., sand control, fracturing, etc.). Also, the general-level design specifies the type of upper and lower completions needed. For example, the lower completion design can specify the type of gravel packing or screens to use. Upper completion design can specify if an artificial lift system is needed, for example. Also, the general-level design can specify the types of instrumentation that may be useful for the completion. Instrumentation may include sensors or gauges to measure downhole and reservoir conditions as well as downhole control devices that are remotely activated, such as valves and the like.

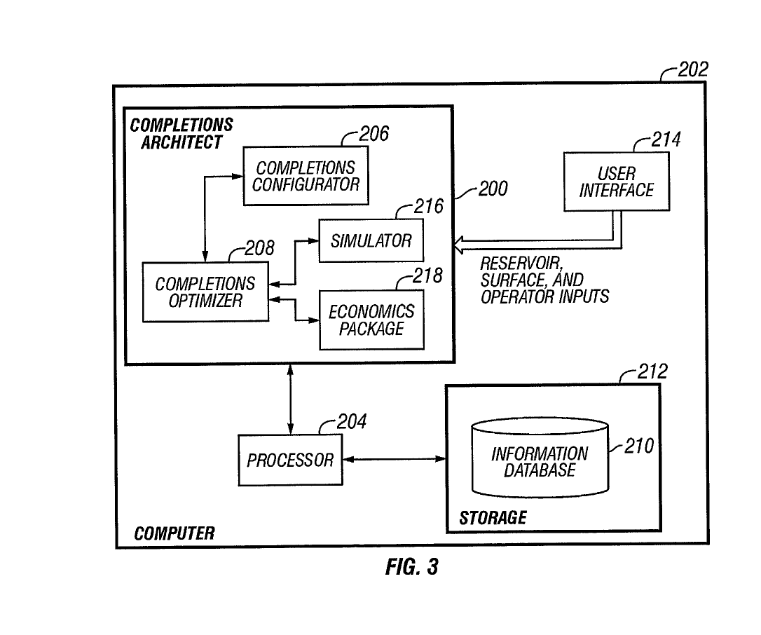

In accordance with some embodiments of the invention, the general-level design is performed using a completions architect tool 200 (FIG. 3), which in one embodiment is a software package that is loaded for execution on a computer system 202. In other embodiments, the completions architect tool 200 can be implemented as a special-purpose hardware information module. The components of and tasks performed by the completions architect tool 200 are discussed further below. The completions architect tool 200 performs “screening” of completion components suitable for a given reservoir setting. This is contrasted with the screening of reservoirs for a given completion technology.

As further shown in FIG. 2, after performance of the general-level design, the detailed design phase is performed (at 102). The detailed design differs from the general-level design in that the detailed design actually specifies the types of components to use in the completion system as well as individual designs of many of those components. For example, valves for a given well may have plural choke positions to provide the desired levels of incremental control. Specific choke aperture sizes can also be determined. As another example, the length of a horizontal completion for optimal performance can be specified. The type of specific components mentioned above are provided as examples only, and are not intended to be exhaustive or to limit the scope of the invention.

Once the detailed design phase (102) is completed, the well planning and design procedure moves into the operation phase (104). During the operation phase (104), the initial model of the well from the design phase (102) is initialized (at 114). The initial model describes the entire system, including the downhole completion system as well as surface facilities, such as pipes, flow lines, and stations for flowing hydrocarbons to various destinations. Continuous adjustments of downhole components or adjustments of a model may be performed in response to monitored conditions in the wellbore.

During the operation phase (104), well measurements are received (at 116). Based on the well measurements, it is determined (at 118) whether settings of the completion system should be adjusted. If so, various downhole components are adjusted (such as settings of valves and so forth) to change the operational characteristics of the completion system. If it is determined that it is not possible to re-align the performance of the completion system to that set by the model, then it can be concluded that the current model is obsolete. There may also be other indicators that the model has become obsolete. As a result, the model is updated (at 120). The acts of the operation phase (104) are repeated during the life of the well.

Thus, as shown in FIG. 2, the operation phase (104) can be represented as having two loops: a relatively slow optimization loop 126 and a faster operation loop 124. The optimization loop 126 re-calibrates the conceptual model of the reservoir and resets operational set points or targets if necessary. The operation loop 124 is performed to check whether the system is performing within specified settings (according to the conceptual model), and if not, to adjust current settings of the completion system.

In one embodiment, the operation loop 124 can be performed at some predetermined frequency, such as daily, weekly, semi-monthly, monthly, etc. The target frequency can be adjusted by the well operator depending on whether or not more frequent or less frequent checks are necessary and whether they are cost effective. In some cases, the frequency of the optimization loop 126 may be quite high when the well is first placed into operation. However, as the model is refined with the acquisition of operational data over time, the need to perform the optimization loop 126 may be less frequent. In a multi-well system, multiple models may be kept for respective wells.

FIG. 3 shows an example arrangement for the completions architect tool 200 that performs the general-level design according to some embodiments of the invention. The completions architect tool 200 is loaded for execution in the computer system 202, which includes a processor 204 on which the completions architect tool 200 is executable.

The completions architect tool 200 includes a completions configurator 206 and a completions optimizer 208. The completions configurator 206 is used to obtain a qualitative design based on knowledge derived from case histories and new completions technology stored in an information database 210. The information database 210 is stored in a storage 212. An optimized high-level completion design is obtained by using the completions optimizer 208.

Through a user interface 214 of the system 202, a user is able to provide various inputs to the completions architect tool 200. Such inputs include information regarding the reservoir (e.g., reservoir structure; petrophyshical properties; flow properties; permeability; etc.), information regarding characteristics of the field (e.g., well surface environment including land, offshore platform, and subsea; size of the field; maturity of the field; etc.), and information regarding the general motives, practices, and constraints of field operation (e.g., immediate drivers such as production acceleration and lift assistance; completions and facilities constraints; intervention practices; etc.).

The completions configurator 206 uses rules (stored in the information database 210) representing the completions knowledge to determine the total completion configuration that is adapted to a given reservoir, well surface arrangement, and operator setting. Generally, the completion design performed by the completions configurator 206 is classified as a rule-based approach. A “rule-based” design approach makes design decisions based on inputs and rules that define decisions based on the inputs. The rules stored in the information database 210 evolve with the development and deployment of new completions technology. Consequently, information pertaining to the new completions technology is added to the information database 210 as the information becomes available.

Effectively, the information database 210 is a repository of information on the case histories of installed completions. A case is defined as a collection of attributes that define the completion and that dictate the selection of completion components. The completion is specified in terms of its architectural components from the reservoir to the well head (trajectory, reservoir-wellbore interface, segmentation and flow control, artificial lift and instrumentation, and so forth), while attributes include the characteristics of the reservoir (structure, permeability, drive), the surface setting (land/platform/subsea), and the operator. The information database 210 contains information on all components of a completion string.

An output of the completions configurator 206 includes a proposed configuration, which is made up of basic well design modules: well trajectory; reservoir-wellbore interface; lower completion; upper completion; and instrumentation. The configuration is determined based on rules governing the nature of each of the modules and the interrelationship between them. Another output of the configurator 206 includes case histories that relate to the proposed configuration. Yet another output of the configurator 206 includes information relating to completions technology that is relevant to the proposed configuration.

The completions optimizer 208 refines the completion architecture determined by the completions configurator 206. The completions optimizer 208 determines the “highlevel” or general-level design of the completion. In some embodiments, the completions optimizer 208 is coupled to a simulator 216 and an economics package 218. Thus, given recommendations of a well trajectory, reservoir-wellbore interface, lower completion, and upper completion by the completions configurator 206, the completions optimizer 208 selects optimum placement, perforation phasing patterns, and other settings to optimize operation of a target well given defined objectives and constraints. The optimizer 208 basically is the quantitative component of the completions architect tool 200 (as opposed to the qualitative component that is provided by the completions configurator 206). The optimizer 208 performs modeling to assess the impact of the proposed configuration on production performance.

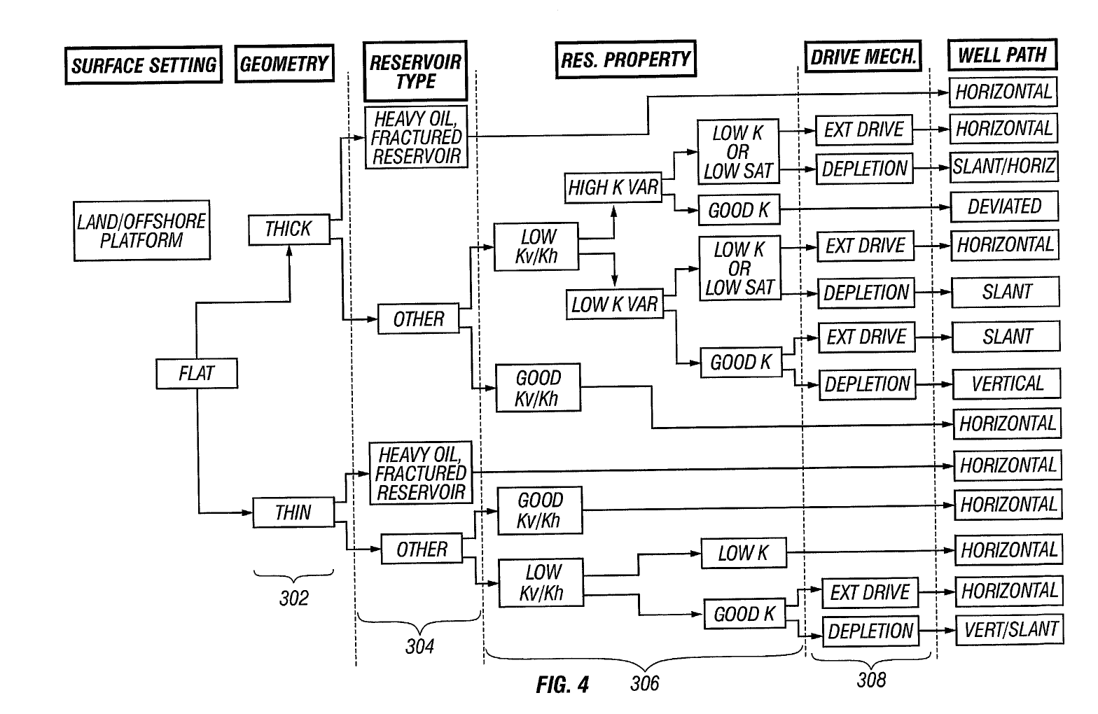

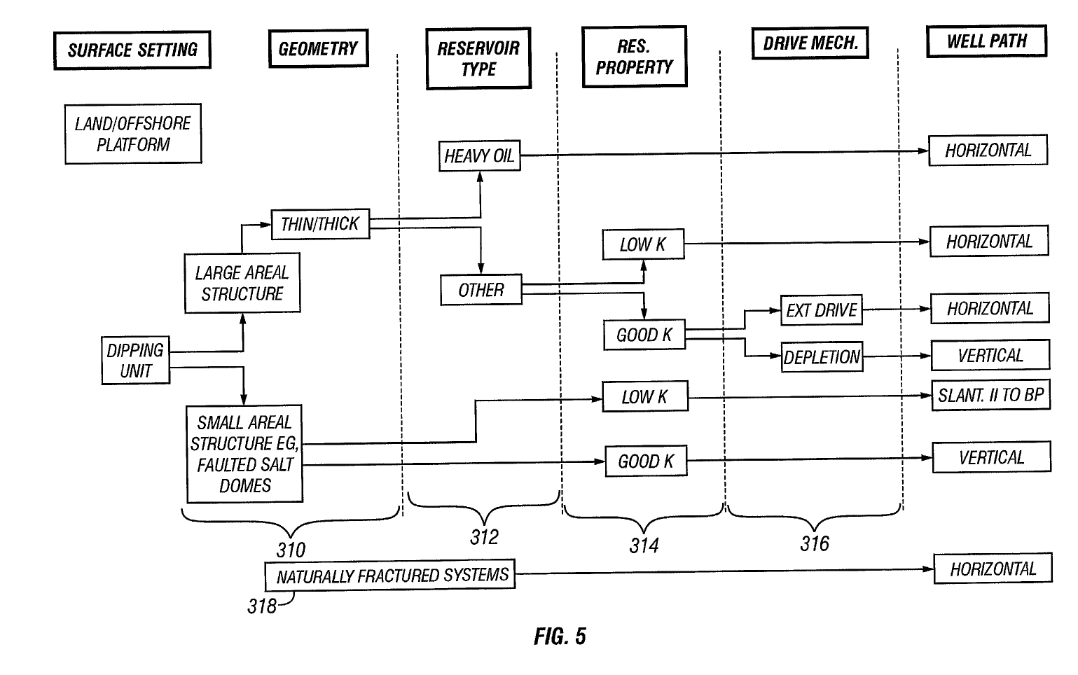

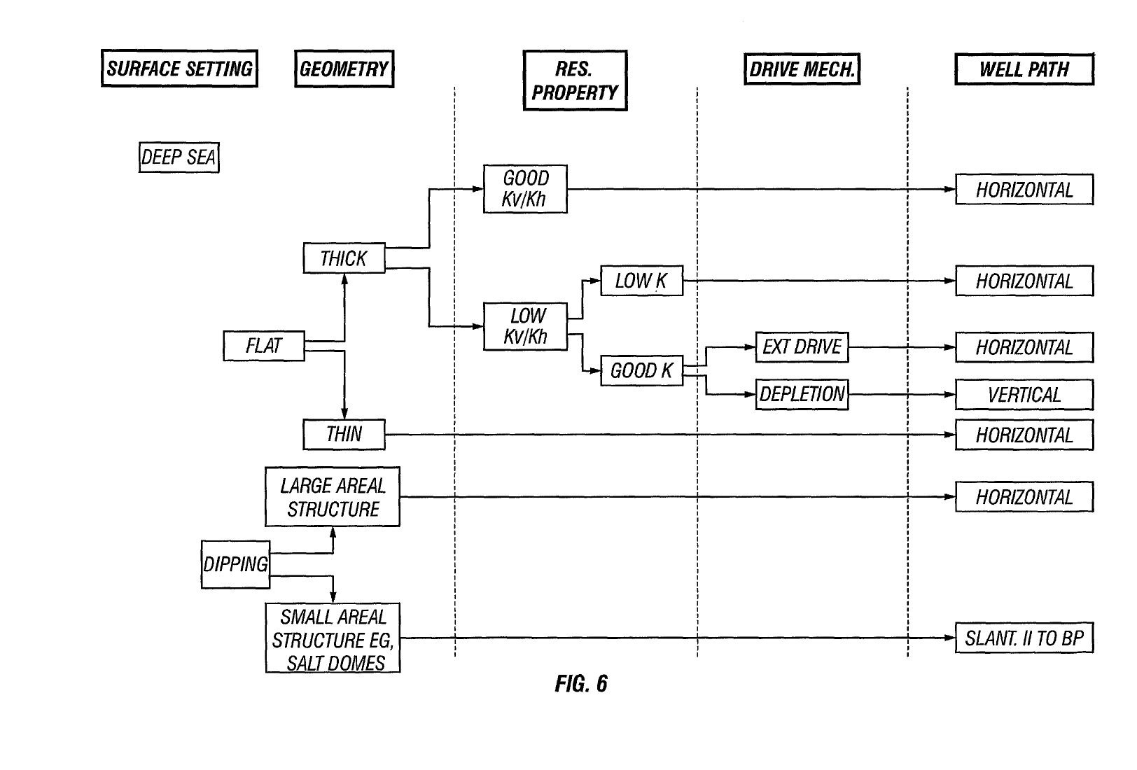

FIGS. 4-6 illustrate the logic that is performed by one embodiment of the completions configurator 206 to select a well trajectory given inputs to the completions architect tool 200. FIG. 4 shows the logic for a well surface setting that includes a land or offshore platform and a reservoir geometry that is generally flat. FIG. 5 shows the logic for a well surface setting that includes a land or offshore platform and a reservoir geometry that has a dipping unit (a reservoir that is not flat but that makes an angle with a horizontal plane). Reservoirs with a relatively small dip angle (e.g., less than 10°) can be treated as flat. FIG. 6 shows the logic for a surface setting that includes a deep sea or subsea setting.

As shown in FIG. 4, for a flat reservoir, the completions configurator 206 first determines (at 302) if the local reservoir structure is thick or thin. After determining whether the local reservoir structure is thick or thin, the completions configurator 206 determines (at 304) whether the reservoir contains heavy oil (oil with high viscosity) or the reservoir is fractured. If the reservoir contains heavy oil or the reservoir is fractured, then increased reservoir exposure by a wellbore is required, which means that a horizontal well trajectory is suggested.

The completions configurator 206 also considers (at 306) reservoir properties in determining what well trajectory to select. The reservoir properties include the permeability (K) of the reservoir. The permeability can be classified as low permeability (low K) or “good” permeability (good K). Another reservoir property is the saturation of the reservoir, including whether the reservoir has low saturation (that is, the reservoir is depleted). Yet another reservoir property is the variation of the permeability. A reservoir with high permeability variation (high K var) is one that is not homogenous. A reservoir with low permeability variation (low K var) is a homogeneous reservoir. Another parameter that is considered is the ratio of the vertical permeability to horizontal permeability (Kv/Kh).

What is considered a “low” or “good” Kv/Kh ratio is determined by settings made by the user. The absolute values of what is considered a low or good Kv/Kh ratio are not important for purposes of some embodiments of the invention. This is true also of other parameters, such as “high” or “low” K variation, “low” or “good” K, “low” saturation, and other relative terms. What is pertinent here is that the completions configurator 206 considers the input characteristics corresponding to the reservoir geometry, reservoir type, reservoir properties, and reservoir drive mechanism in selecting the well trajectory.

The completions configurator 206 also considers (at 308) the drive mechanism of the reservoir. The reservoir can include an external drive, e.g., water driven, gas driven, or dual driven (driven by both water and gas). For example, a reservoir can be driven by water in an aquifer below the reservoir. Another type of drive mechanism is a depletion drive mechanism, which includes solution gas drive.

Based on the various inputs, including reservoir geometry 302, reservoir type 304, reservoir properties 306, and reservoir drive mechanism 308, the completions configurator 206 selects a well trajectory: horizontal trajectory, slant trajectory, or vertical trajectory. A slant trajectory refers to a deviated wellbore that is drilled at an angle with respect to the reservoir.

Thus, according to the logic of FIG. 4, for a flat reservoir that contains heavy oil or that is fractured, a horizontal well trajectory is recommended by the completions configurator 206. For a flat, thick reservoir that does not have heavy oil or that is not fractured, a horizontal well trajectory is recommended by the completions configurator 206 in one of three circumstances: (1) the ratio of the vertical permeability to the horizontal permeability (Kv/Kh) is good; (2) the ratio Kv/Kh is low, the permeability variation is high, the reservoir has a low permeability or low saturation, and the drive mechanism is an external drive mechanism; and (3) the Kv/Kh ratio is low, the reservoir has a low permeability or low saturation, and the reservoir has an external drive mechanism.

In a flat, thick reservoir that does not contain heavy oil or that is not fractured, that has a low Kv/Kh ratio, and that has a low permeability variation, a slant well trajectory is recommended in one of two circumstances: (1) the reservoir has a low permeability or low saturation and the external drive mechanism is a depletion drive mechanism; and (2) the reservoir has a low permeability variation but a good permeability with a external drive mechanism.

For a flat, thick reservoir, a vertical well is suggested in the following circumstance: the reservoir does not contain heavy oil or is not fractured, the Kv/Kh ratio is low, the permeability variation is low, the permeability is good, and the reservoir has a depletion drive mechanism. For a flat, thick reservoir that does not contain heavy oil or that is not fractured, either a slant or horizontal trajectory can be selected in the following circumstance: the Kv/Kh ratio is low, the permeability variation is high, the reservoir has low permeability or low saturation, and the drive mechanism is a depletion drive mechanism.

For a flat, thin reservoir that does not contain heavy oil or that is not fractured, a horizontal well trajectory is recommended in one of the following three circumstances: (1) the Kv/Kh ratio is good; (2) the Kv/Kh ratio is low and the permeability is low; and (3) the Kv/Kh ratio is low, the permeability is good, and an external drive mechanism is present. A vertical or slant well trajectory is recommended for a flat, thin reservoir that does not contain heavy oil or that is not fractured in the following circumstance: the Kv/Kh ratio is low, the permeability is good, and the drive mechanism is a depletion drive mechanism.

As shown in FIG. 5, for a surface setting that has a land or offshore platform in a reservoir that contains a dipping unit, the reservoir geometry considered by the completions configuration 206 includes whether the reservoir has a large areal structure or a small areal structure. The areal structure is related to the volume of the reservoir. The larger the areal structure, the larger the volume of the reservoir. An example of a reservoir with a small areal structure is one with a faulted salt dome.

The completions configurator 206 also determines (at 312) the reservoir type, including whether the reservoir contains heavy oil or not. Also, the completions configuration 206 considers (at 314) a reservoir property, including the permeability (low K or good K). The completions configurator 206 also considers (at 316) the drive mechanism (external drive mechanism or depletion drive mechanism). In addition, the completions configuration 206 considers (at 318) whether the reservoir is a naturally fractured system. If the reservoir is a naturally fractured system, then the completions configurator 206 recommends a horizontal well trajectory.

For a reservoir having a large areal structure, a horizontal well trajectory is recommended if the reservoir contains heavy oil, since greater exposure of the reservoir to the wellbore is needed in this case. For a reservoir having a large areal structure but which does not have heavy oil, then a horizontal trajectory is recommended in one of the following two circumstances: (1) the reservoir has a low permeability; and (2) the reservoir has a good permeability and an external drive mechanism.

For a reservoir having a large areal structure but that does not contain heavy oil, a vertical well trajectory is recommended if the reservoir has good permeability but the drive mechanism is a depletion drive mechanism.

For a reservoir having a small areal structure, then a slant well that is parallel to a bedding plane in the reservoir is recommended for enhanced exposure. However, for a reservoir having a small areal structure with good permeability, a vertical well structure is recommended as a cheaper alternative.

FIG. 6 shows selection of the well trajectory for a well having a deep sea or subsea surface setting. If the reservoir is flat, then a horizontal well trajectory is recommended in one of the following four circumstances: (1) the reservoir is a thin reservoir; (2) the reservoir is a thick reservoir with a good Kv/Kh ratio; (3) the reservoir is a thick reservoir with a low Kv/Kh ratio and low permeability; (4) the reservoir is a thick reservoir with a low Kv/Kh ratio, good permeability and an external drive mechanism. A vertical well trajectory is recommended for a flat, thick reservoir if the reservoir has a low Kv/Kh ratio and good permeability but the drive mechanism is a depletion drive mechanism.

For a reservoir that has a dipping unit, a horizontal well trajectory is recommended if the reservoir contains a large areal structure, but a slant well that is parallel to the bedding plane is recommended if the reservoir contains a small areal structure.

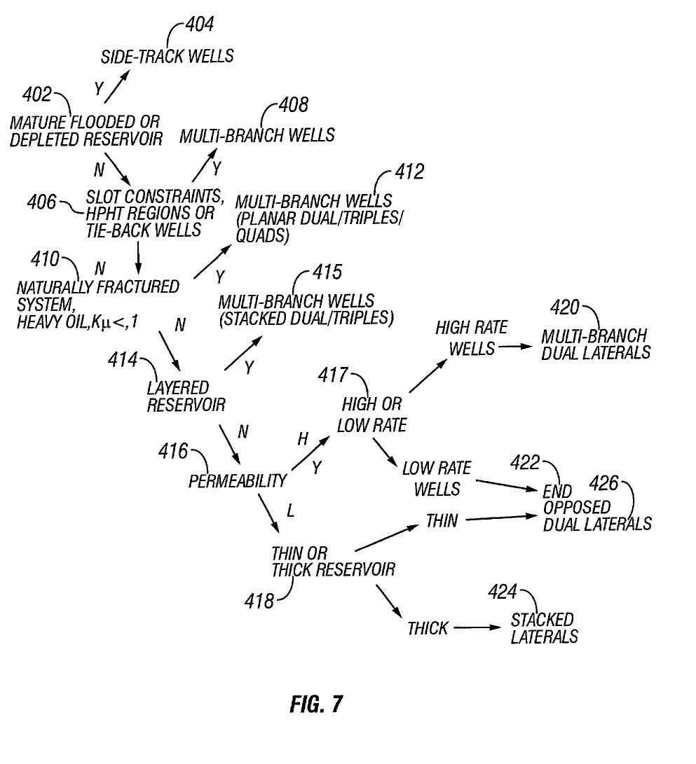

FIG. 7 shows the logic performed by the completions configurator 206 to determine the applicability of a multilateral well. The completions configurator 206 first determines (at 402) if the well has a mature, flooded or depleted reservoir. If so, then a side-track well is recommended (at 404). A mature well typically already has established wellbores drilled into the reservoir. A side-track well basically is a lateral that extends from an existing wellbore to a target reservoir region.

If the completions configurator 206 determines (at 402) that the well does not include a mature, flooded or depleted reservoir, then the completions configurator determines (at 406) if there are slot constraints, if the well has high pressure, high-temperature (HPHT) regions, or if tie-back wells are present. If any of the three factors is true, then a multi-branch or multilateral well is recommended (at 408). A slot constraint refers to the number of slots available on an offshore platform from which well equipment can be hung for insertion into corresponding wellbores. If a slot constraint exists, meaning that there is a limited number of slots available on the platform, then a multi-branch well is desirable to maximize the usage of each slot on the platform. High-pressure, high-temperature regions in a well result in relatively expensive upper-hole operational costs and, as a result, it is desirable to have a multi-branch well to reduce the number of wellbores that need to be drilled into a reservoir. A tie-back well is a well that ties a remote reservoir back to an existing production infrastructure. The remote reservoir is typically a relatively small reservoir with a relatively small amount of produceable hydrocarbons. If tie-back wells are needed, it is more cost-efficient to use a multi-branch well.

If the factors determined at 406 are all not true, then the completions configurator 206 determines (at 410) if the well includes a naturally fractured system or if heavy oil is present in the reservoir. Heavy oil is indicated by the ratio of permeability (K) to viscosity (μ) being less than 0.1 (or some other predefined value). If either factor determined at 410 is true, then the completions configurator 206 recommends (at 412) a multi-branch well. The recommended multi-branch well has a planar structure in which laterals from a main wellbore extend generally in the same plane. The multi-branch well can be one of a dual-branch (2 lateral bores) well, a triple-branch (3 laterals bores) well, a quad-branch (4 lateral bores) well, and so forth.

If the factors determined at 410 are not true, then the completions configurator 206 determines (at 414) if the well includes a layered reservoir. A layered reservoir is a reservoir that has many layers of hydrocarbons that do not communicate with each other or have poor communication with each other. If the well has a layered reservoir, then the completions configurator 206 recommends (at 415) a multi-branch well that is stacked. A stacked multi-branch well includes multiple lateral bores that are vertically spaced apart so that one lateral bore is vertically over another lateral bore.

If the well does not include a layered reservoir as determined at 414, then the completions configurator 206 determines (at 416) the permeability of the reservoir. If the reservoir has high permeability, then the completions configurator 206 determines (at 418) if the well is expected to be high-rate well or a low-rate well. If a high-rate well, then a multi-branch well is recommended (at 420). If the well is a low-rate well, then a multi-branch well is not recommended (at 422).

If the permeability of the reservoir is low, as determined at 416, then the geometry of the reservoir is determined (at 418). If the reservoir is relatively thick, then a multi-branch well having stacked lateral bores is recommended (at 424). However, if the reservoir is relatively thin, then a multi-branch well having opposed laterals is recommended (at 426).

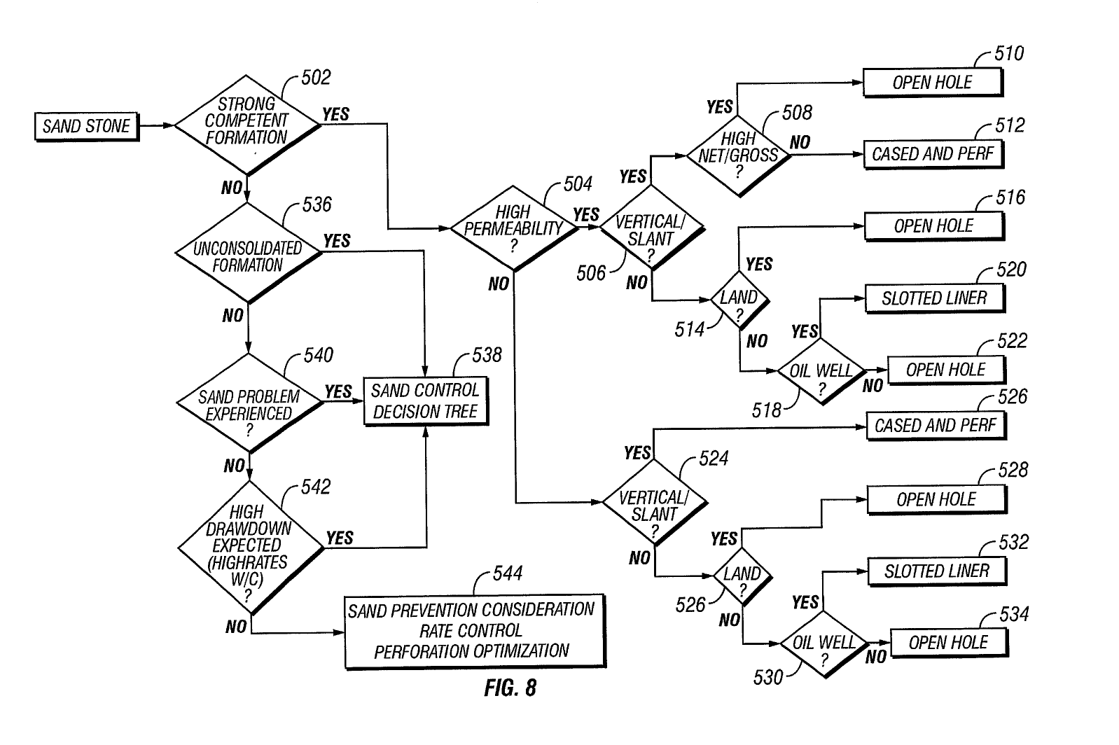

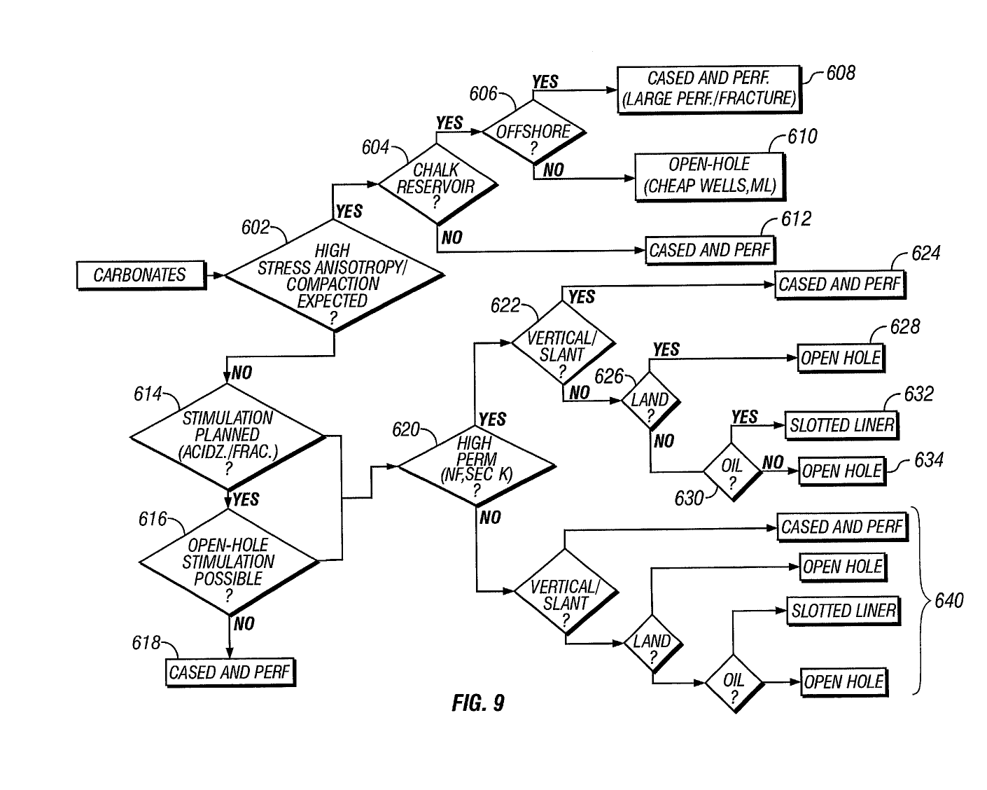

FIG. 8 shows the logic implemented by the completions configurator 206 for selection of the interface between the reservoir and the wellbore for a sandstone reservoir. FIG. 9 is the logic implemented by the completions configurator 206 for the interface between the reservoir and the wellbore for a carbonate reservoir.

As shown in FIG. 8, for a sandstone reservoir, the completions configurator 206 first determines (at 502) if the reservoir is in a strong, competent formation, that is, a formation that will not collapse in the presence of the relatively large differential pressure created between the reservoir and the wellbore. If the formation is a strong, competent formation, the completions configurator 206 determines the permeability (at 504) of the reservoir. If the reservoir has high permeability, then the completions configurator 206 determines (at 506) if the wellbore is a vertical or slant wellbore.

If the wellbore is a vertical or slant wellbore (that is, not a horizontal wellbore), the completions configurator 206 determines (at 508) if the ratio of the net reservoir thickness to gross reservoir thickness is high. A reservoir may have scattered pockets of hydrocarbons, which effectively reduces its net thickness even though its gross or total thickness may be large. If the ratio of the net thickness to gross thickness is high, then a open hole is recommended (at 510). However, if the ratio of the net thickness to gross thickness is low, then a cased and perforated wellbore is recommended (at 512).

At 506, if the completions configurator 206 determines that the wellbore is not vertical or slanted (meaning that the wellbore is horizontal), then the completions configurator 206 determines (at 514) if the well is a land well. If so, the completions configurator recommends an open hole (at 516). However, if the completions configurator determines at 514 that the well is not a land well, meaning that the well is an offshore well, then the completions configurator 206 determines (at 518) if the well is an oil well or a gas well. If an oil well, then a slotted liner is recommended (at 520) to provide some support for the wellbore. However, if the well is a gas well, then an open hole is recommended (at 522). A slotted liner is not desirable for a gas well.

At 504, if the completions configurator determines that the reservoir has low permeability, then the completions configurator determines (at 524) if the well is a vertical or slant well. If the well is a vertical or slant well, then the completions configurator recommends (at 526) a cased and perforated wellbore. However, if the well is a horizontal well, as determined at 524, the completions configurator determines (at 526) if the well is a land well. If so, an open hole wellbore is recommended (at 528). If not a land well, then the completions configurator determines (at 530) if the well is an oil well or gas well. If an oil well, then a slotted liner is recommended (at 532). If a gas well, then an open hole is recommend (at 534).

At 502, if the completions configurator 206 determines that the reservoir is not in a strong, competent formation, then the completions configurator determines (at 536) if the formation is consolidated or unconsolidated. If unconsolidated, then the completions configurator 206 performs (at 538) a sand control decision logic, which is described further below.

If the formation is a consolidated formation, then the completions configurator determines (at 540) if sand problem has been experienced. If so, then the sand control decision logic is performed (at 538). If not, then the completions configurator 206 determines (at 542) if high drawdown is expected. If so, then the sand control decision logic is performed. If high drawdown is not expected, then the completions configurator 206 performs sand prevention consideration (at 544) by recommending rate control (to limit the rate of fluid production) and perforation optimization to reduce the likelihood of sand production.

FIG. 9 shows selection of the reservoir-wellbore interface for a carbonate reservoir. First, the completions configurator 206 determines (at 602) if high stress anisotropy or compaction is expected; that is, whether there is a large difference between horizontal and vertical (or any perpendicular) stresses. Vertical stress increases with depth. Horizontal stress may be significant if the area has been tectonically active. Large contrasts cause problems of wellbore stability and hence call for a completion measure to support the well.

If high stress anisotropy or compaction is expected, the completions configurator determines (at 604) if the reservoir is a chalk reservoir. If so, the completions configurator 206 determines (at 606) if the well is an offshore well. If so, then a cased and perforated well is recommended (at 608). If not an offshore well, then an open hole is recommended (at 610).

At 604, if the completions configurator 206 determines that the reservoir is a chalk reservoir, then a cased and perforated wellbore is recommended (at 612). A chalk reservoir is located in a rock that is chalk—rock that has rich organic origins and chemically is a carbonate compound (e.g., calcium, magnesium, etc.), and is soft or ductile.

At 602, if high stress anisotropy or compaction is not expected, then the completions configurator 206 determines (at 614) if stimulation is planned. Stimulation includes acidizing the well or fracturing the well. If stimulation is planned, then the completions configurator 206 determines (at 616) if open-hole stimulation is possible. If not, then a cased and perforated well is recommended (at 618). If either stimulation is not planned, or open-hole stimulation is possible, then the completions configurator 206 determines (at 620) if the reservoir has a high permeability. If so, the completions configurator 206 determines (at 622) if the well is a vertical or slantwell. If the well is vertical or slanted, then the configurator 206 recommends (at 624) a cased and perforated well. However, if the well is not vertical or slanted (that is, the well is horizontal), the completions configurator determines (at 626) if the well is a land well or offshore well. If a land well, then an open hole well is recommended (at 628). If an offshore well, then the completions configurator determines (at 630) if the well is an oil well or gas well. If an oil well, then a slotted liner is recommended (at 632). If a gas well, then an open hole is recommended (at 634).

At 620, if the reservoir permeability is low, then the logic (at 640) is performed. As shown in FIG. 9, the logic at 640 is the same as the logic following the “YES” branch from the decision box 620. However, in other cases, the logic can be defined by the user to be different.

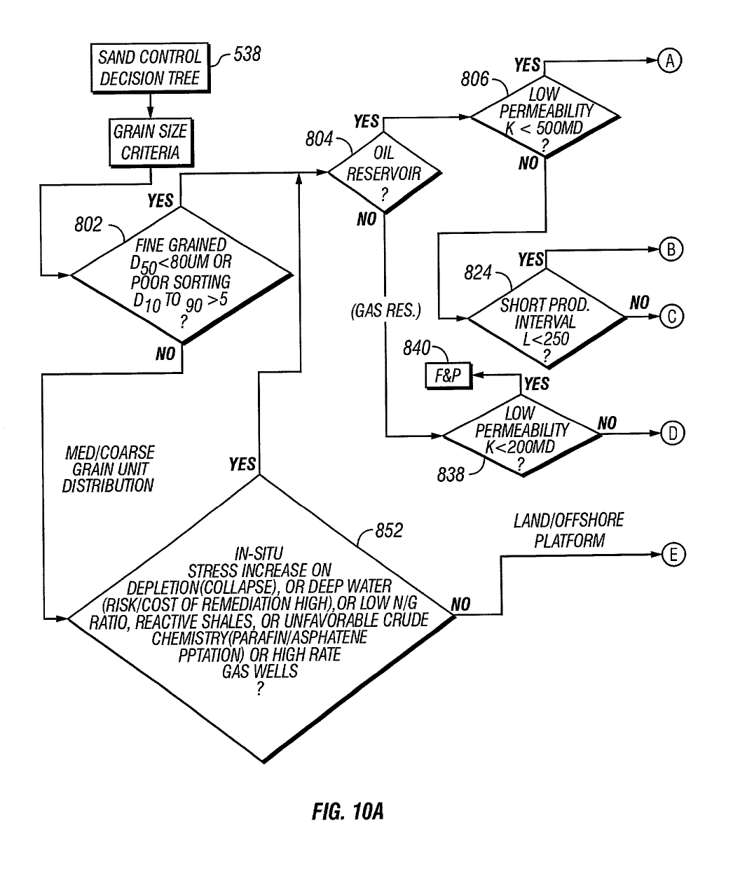

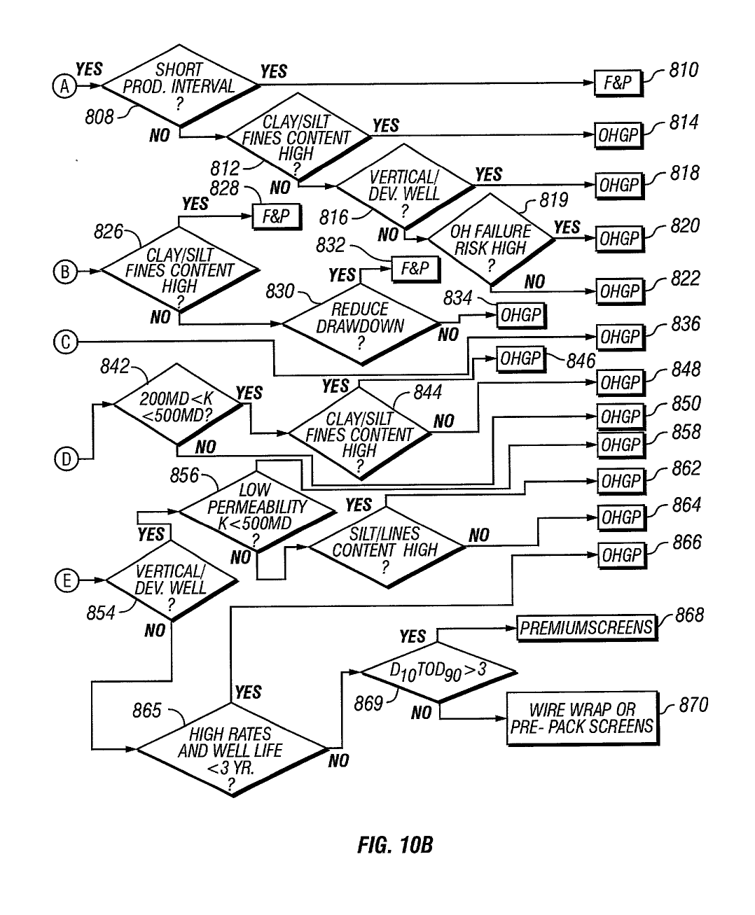

As noted above in connection with FIG. 8, a sand control decision logic 538 is performed under certain conditions to select a lower completion configuration. As shown in FIG. 10, the completions configurator 206 determines (at 802) if the sand in the formation containing the reservoir is fine grained (D₉₀<80 micrometers or some other predefined value) or poor sorting of grains is present in the formation (D₁₀/D₉₀>5 or some other predefined ratio). If either condition is present, then the completions configurator 206 determines (at 804) if the reservoir is an oil reservoir or gas reservoir. If an oil reservoir, then the completions configurator determines (at 806) if the reservoir has low permeability. Low permeability may be defined as K<500 millidarcies or some other predefined value. If the reservoir is a low permeability reservoir, then the completions configurator 206 determines (at 808) if the production interval is short (e.g., the interval L>250 feet or some other predefined length). If so, then a fracture and pack arrangement is recommended for the lower completion (at 810).

However, if the production interval is not short, then the configurator 206 determines (at 812) if the clay, silt, or fines content in the reservoir is high. If so, then an open-hole gravel pack is recommended (at 812). However, if the clay, silt, and fines content in the reservoir is low, then the completions configurator 206 determines (at 816) if the well is a vertical or slant well. If the well is a vertical or slant well, then the configurator 206 recommends (at 818) a cased-hole gravel pack. If, however, the well is a horizontal well, then the completions configurator 206 determines (at 819) if open hole failure risk is high. If so, then a cased-hole gravel pack is recommended (at 820). If the open hole failure risk is low, then an open-hole gravel pack is recommended (at 822) for the horizontal well.

At 806, if the configurator 206 determines that the reservoir does not have low permeability, then the configurator determines (at 824) if the production interval is short. If short, the configurator 206 determines (at 826) if the clay, silt, or fines content is high. If high, then a fracture and pack arrangement is recommended (at 828). However, if the clay, silt, fines content is not high, then the configurator 206 determines (at 830) if reduction of drawdown is desired due to poor reservoir pressure, near-wellbore damage, or sand control. If drawdown reduction is desired, then a fracture and pack lower completion arrangement is recommended (at 832). However, if reduction of drawdown is not desired, then an open-hole gravel pack is recommended (at 834).

At 824, if the configurator 206 determines that the production interval is not short, then an open-hole gravel pack is recommended (at 836) for the lower completion.

At 804, if the configurator 206 determines that the reservoir is a gas reservoir, then the configurator 206 determines (at 838) if the reservoir has a low permeability. If so, then a fracture and pack lower completion is recommended (at 840). If the formation has high permeability, then the configurator 206 determines (at 842) if the permeability K is in the range between 200 millidarcies and 500 millidarcies. If so, the configurator 206 determines (at 844) if the clay, silt, or fines content is high. If high, then an open-hole gravel pack is recommended (at 846). If the clay, silt, fines content is not high, then a cased-hole gravel pack is recommended (at 848).

If the permeability K is less than 200 millidarcies or great than 500 millidarcies, as determined at 842, then an open-hole gravel pack is recommended (at 850).

If the configurator 206 determines at 802 that the formation has medium or coarse grain and the distribution of grains is uniform, then the configurator 206 performs (at 852) a determination of various factors. The factors include in situ stress increase on depletion (collapse), a deep water well (where the risk and cost of remediation is high), a low net-to-gross thickness ratio, reactive shales (which means shales that are reactive to water which may swell to block fluid flow paths), unfavorable crude chemistry (e.g., precipitation of paraffin or asphaltene), or a high-rate gas well.

If any of the factors is evaluated to be true, then the processing of 804 through 850 is performed. However, if all the factors are evaluated to be false, then the configurator 206 determines (at 854) if the well is a vertical or slant well. If a vertical or slant well, then the configurator 206 (at 856) determines if the reservoir has a low permeability. If so, then the configurator 206 recommends a cased-hole gravel pack (at 858). However, if the reservoir has high permeability, as determined at 856, then the configurator 206 determines (at 860) if the silt or fines content is high. If high, then the configurator 206 recommends (at 862) an open-hole gravel pack. Otherwise, a cased-hole gravel pack is recommended (at 864).

At 854, if the configurator 206 determines that the well is a horizontal well, then the configurator 206 determines (at 866) if the well is a high-rate well and if the life of the well is less than three years. If so, then an open-hole gravel pack is recommended (at 866). However, if neither of those two conditions are true, the configurator 206 determines the ratio of D₁₀ to D₉₀, which indicates the sorting of the grains of the formation. If the ratio of the D₁₀ to D₉₀ is greater than 3 (or some other predefined value), as determined at 869, then premium screens are recommended (at 868). However, if the ratio is not greater than 3, then a wire wrapped screen or pre-packed screen is recommended (at 870).

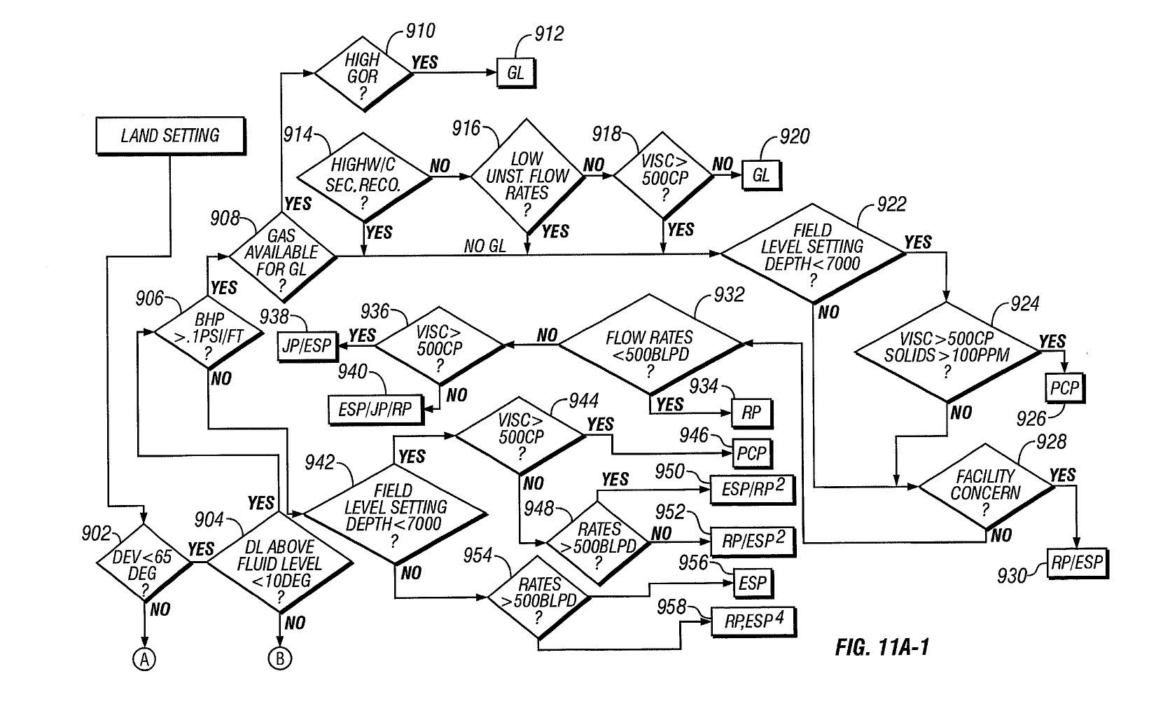

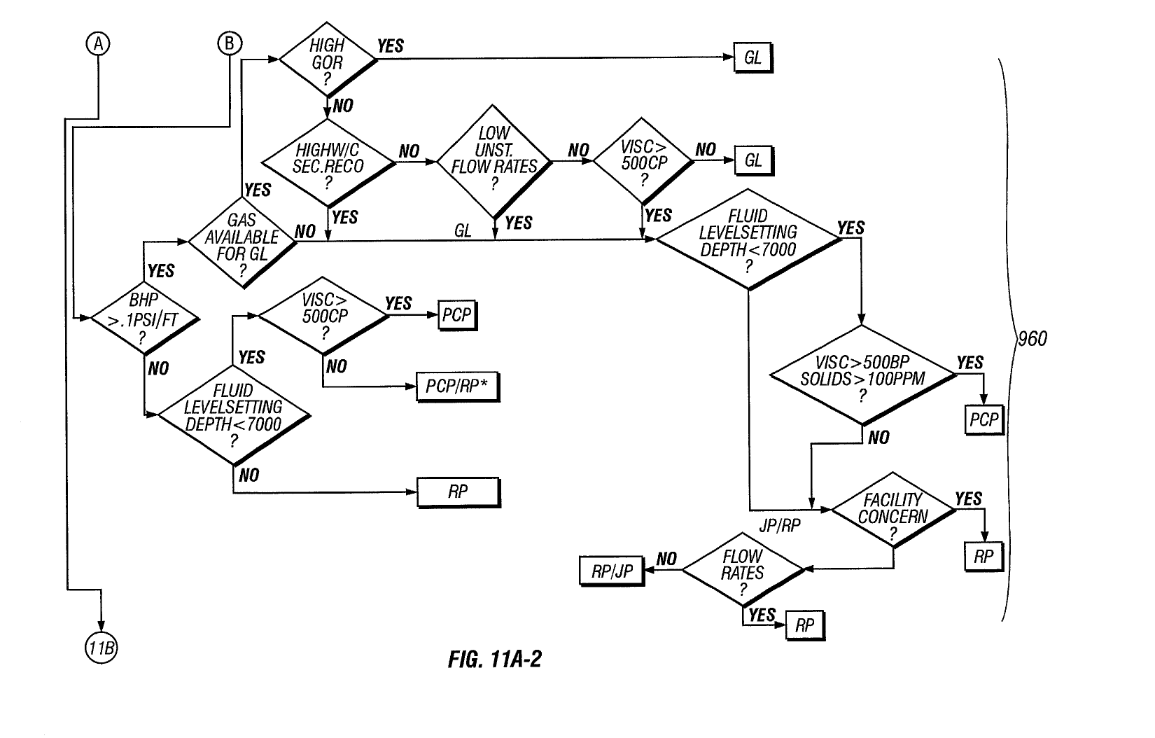

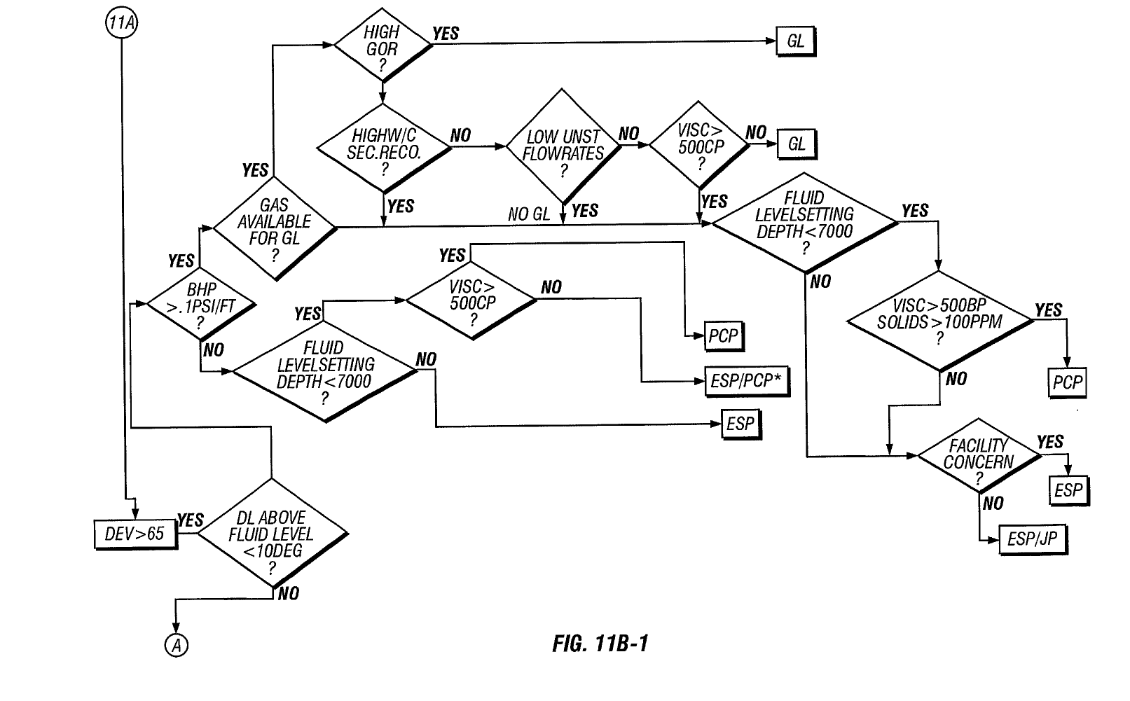

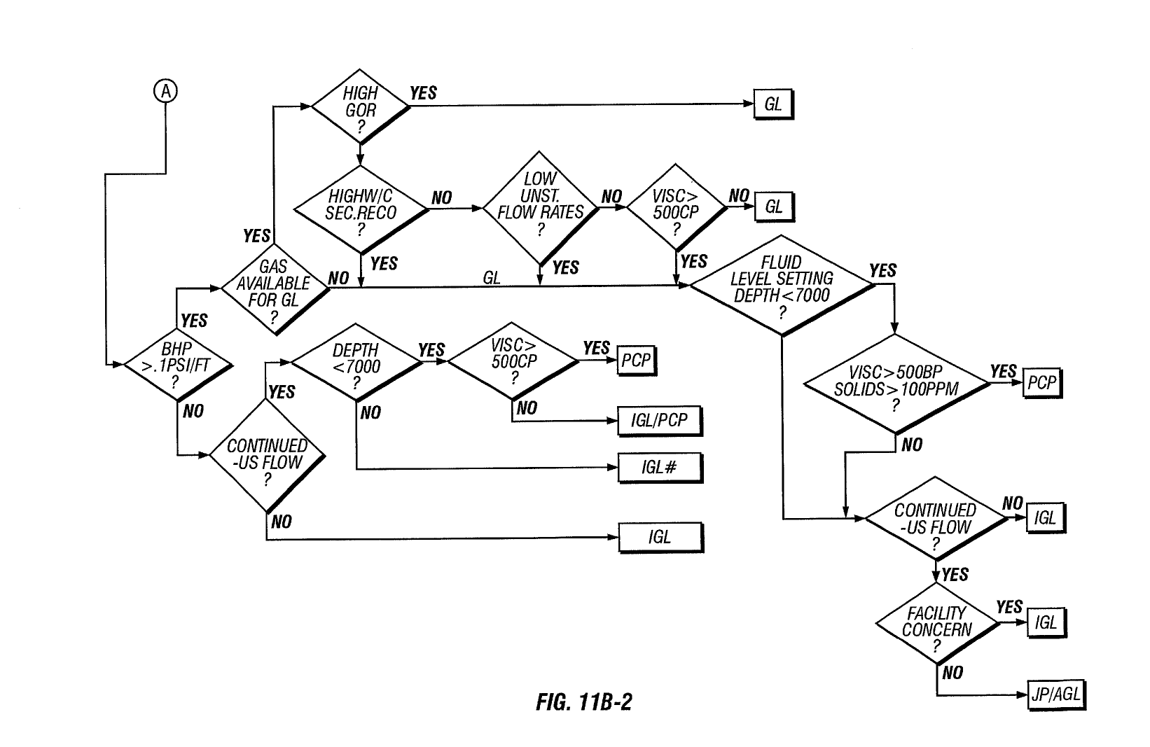

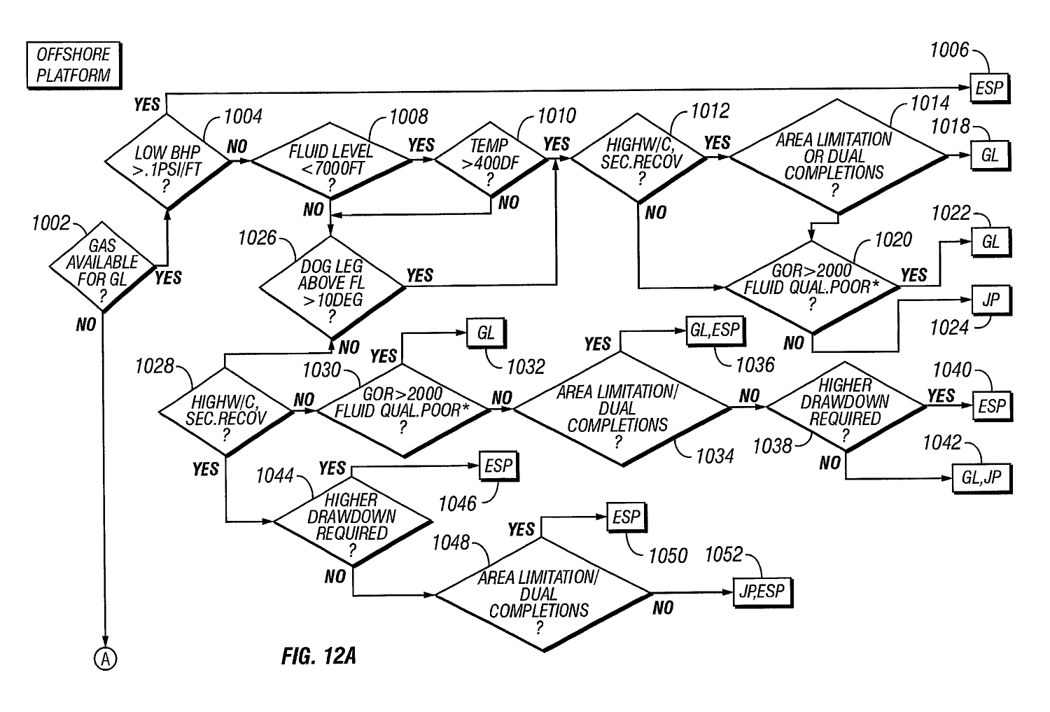

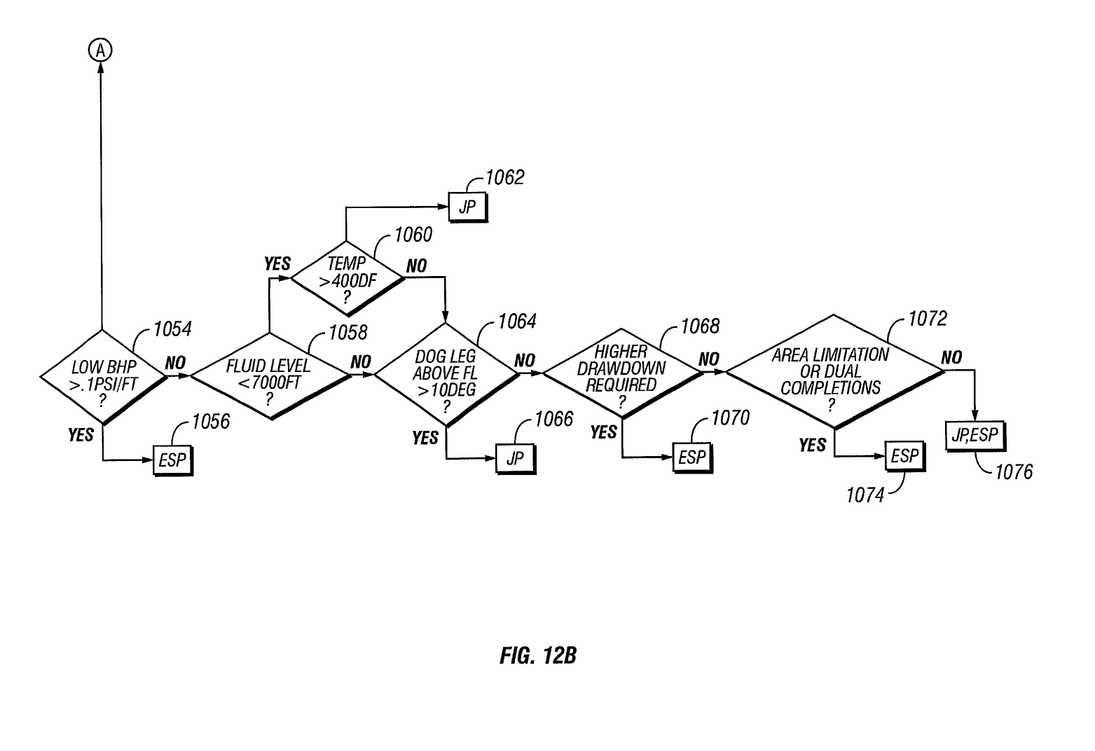

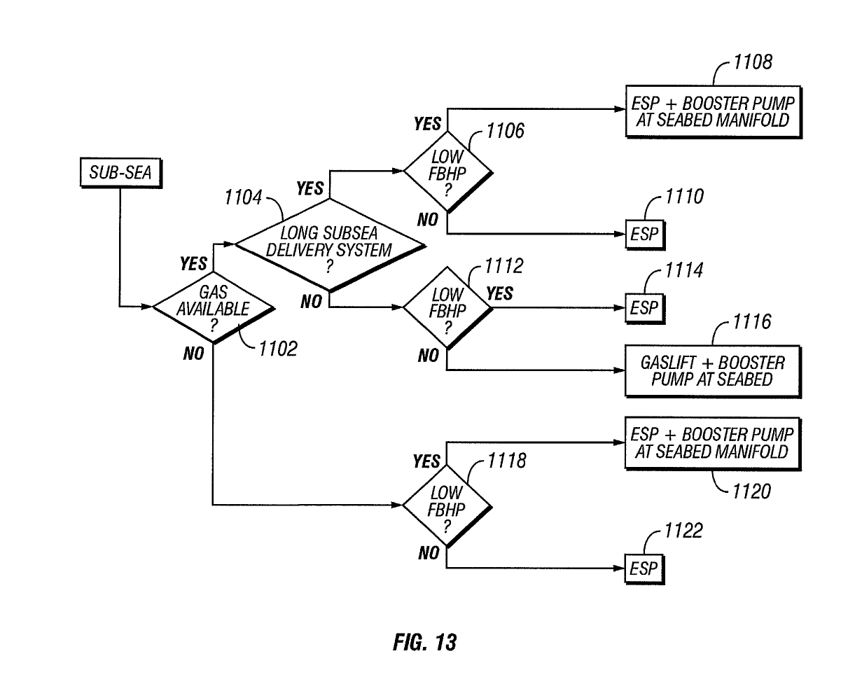

FIGS. 11A-11B show the logic performed by the completions configurator 206 for a land setting in selecting the artificial lift for the upper completion. FIG. 12 shows the logic performed by the configurator 206 for an offshore well with offshore platform to select the artificial lift for the upper completion. FIG. 13 shows the logic performed by the configurator 206 for a subsea well to select an artificial lift system.

As shown in FIGS. 11A-11B, for a land setting, the configurator 206 first determines (at 902) if the deviation of the well is less than 65° (or some other predefined angle). If not, then the process according to FIG. 11B is performed. However, if the deviation of the well is less than 65°, then the configurator 206 determines (at 904) if a “dog leg” is present above the fluid level, and if so, if the angle of the dog leg is less than 10°. A dog leg refers to a sharp turn of the wellbore. If the dog leg above the fluid level is less than 10°, then the configurator 206 determines (at 906) if the bottom-hole pressure gradient is greater than 0.1 psi/ft (or some other predefined pressure). If gas is available, then the configurator 206 determines (at 908) if gas is available for gas lift purposes. If so, then the configurator 206 determines (at 910) if the gas-to-oil ratio in the reservoir is high. If so, then a gas lift system is recommended (at 912).

However, if the gas-to-oil ratio is low, then the configurator 206 determines (at 914) if high water-cut secondary recovery is present. High water-cut refers to a high ratio of water in the produced fluid. High water-cut secondary recovery refers to a high ratio of produced water for a reservoir that is produced by application of an external energy (such as by injection of water through another well). If high water-cut secondary recovery is not present, then the configurator 206 determines (at 916) if low unstable flow rates are expected in a wellbore. If low unstable flow rates are not expected, then the configurator 206 determines (at 918) if the viscosity of the oil is greater than 500 centipoise (cp) (or some other predetermined viscosity). If not, then a gas lift system is recommended (at 920). However, if any of the conditions evaluated at 914, 916, or 918 is true, or if gas is determined (at 908) not to be available for a gas-lift system, then the configurator 206 determines (at 922) if the fluid level or setting depth is less than 7000 feet (or some other predetermined depth). If so, then a shallow well is indicated, and the configurator 206 determines (at 924) if the reservoir fluid viscosity is greater than 500 cp and the amount of solids is greater than 100 parts per million (ppm) (or some other predetermined value). If so, then a progressive cavity pump is recommended (at 926) to handle viscous oil or oil with high levels of abrasives.

If the fluid level or setting depth is not less than 7000 feet (as determined at 922), or if the viscosity of the oil is not greater than 500 cp or the amount of solids is not greater than 100 ppm, then the configurator 206 determines (at 928) if there is a “facility” concern. A facility concern indicates that there is no surface facility (such as in a subsea well environment). If there is a facility concern, then a rod pump or electrical submersible pump is recommended (at 930).

However, if there is not a facility concern, the configurator 206 determines (at 932) if the flow rates in the wellbore is expected to be less than 500 barrels of liquid per day (BLPD). If so, then a rod pump is recommended (at 934). However, if the flow rates are expected to not be less than 500 BLPD, then configurator 206 determines (at 936) if the viscosity of the oil is greater than 300 cp (or some other predetermined value). If so, then a jet pump or electrical submersible pump is recommended (at 938), with the jet pump preferred. However, if the viscosity of the oil is not greater than 300 cp, then an electrical submersible pump, jet pump, or rod pump is recommended (at 940), with the electrical submersible pump preferred, followed by the jet pump, then followed by the rod pump.

At 906, if the bottom-hole pressure gradient is greater than 0.1 psi/ft, then the configurator 206 determines (at 942) if the well is a shallow well (e.g., fluid level or setting depth less than 7000 feet). If so, then configurator 206 determines (at 944) if the viscosity is greater than 500 cp (or some other predetermined value). If so, then a progressive cavity pump is recommended (at 946). If the viscosity is determined at 944 to be not greater than 500 cp, then the expected rate of the fluid production is determined (at 948). If the expected rate is greater than 500 BLPD, then an electrical submersible pump is indicated (at 950) as being preferred in the recommendation over the rod pump, since the rod pump has a poorer efficiency at higher rates. However, if the fluid flow rate is expected not to be greater than 500 BLPD, then a rod pump is recommended to be preferred over an electrical submersible pump (at 952).

At 942, if the well is determined not to be a shallow well, then the configurator 206 determines (at 954) if the expected fluid rate is greater than 500 BLPD. If so, then an electrical submersible pump is recommended (at 954). However, if the fluid flow rate is less than 500 BLPD, then a rod pump is recommended over an electrical submersible pump (at 958).

If a dog leg having an angle greater than 10° is determined (at 904) to be present, then the configurator 206 performs similar determinations (at 960) to determine if a gas-lift system or some type of pump is suitable.

Similarly, for a well having a deviation that is greater than 65°, the acts performed in FIG. 11B are similar to the determinations made by configurator 206 in FIG. 11A to select whether a gas-lift system or some type of pump is suitable for the well. In FIG. 11B, “IGL” stands for intermittent gas lift and continuous flow means that the well is productive enough to flow continuously.

FIG. 12 shows the logic to select the artificial lift for an offshore well. The completions configurator 206 determines (at 1002) if gas is available for a gas lift system. If so, the completions configurator 206 determines if the bottom hole pressure gradient is low (e.g., less than 0.1 psi/ft.). If the bottom-hole pressure gradient is low, then the configurator 206 recommends (at 1006) an electrical submersible pump.

If the bottom-hole pressure is not low, then the configurator 206 determines (at 1008) if the well is a deep well (e.g., fluid level greater than 7000 feet). If the well is a deep well, then the configurator 206 determines (at 1010) if the well temperature is greater than a predetermined value (e.g., 400° F.). If so, the configurator 206 determines (at 1012) if high water-cut secondary recovery is expected. If high water-cut secondary recovery is expected, then the configurator 206 determines (at 1014) if there is an area limitation or if a dual completion is installed in the well. If there is an area limitation or a dual completion has been installed in the well, then a gas-lift system is recommended (at 1018). However, if the configurator 206 determines (at 1014) that there is not an area limitation or a dual completion, or if the configurator 206 determines (at 1012) that high water-cut secondary recovery is not expected, then the configurator 206 determines (at 1020) if the gas-to-oil ratio is greater than a predetermined value (e.g., 2000), which indicates that the fluid quality is poor. If the fluid quality is poor, then a gas-lift system is recommended (at 1022). However, if the fluid quality is determined not to be poor at 1020, the configurator 206 recommends a jet pump (at 1024).

If the configurator 206 determines (at 1008) that the well is not a deep well, or the configurator 206 determines (at 1010) that the temperature is not greater than 400° F., then the configurator 206 determines (at 1026) if a dog leg above the fluid level has an angle greater than 10°. If the dog leg has an angle greater than 10°, then the process performed at 1012, 1014, 1018, 1020, 1022 and 1024 are performed. However, if there is not a dog leg having an angle greater than 10°, the configurator 206 determines (at 1028) if high water-cut secondary recovery is expected. If high water-cut secondary recovery is not expected, the configurator 206 determines (at 1030) if the gas-to-oil ratio is greater than 2000 to indicate that fluid quality is poor. If the fluid quality is poor, then the configurator 206 recommends (at 1032) a gas-lift system. However, if the fluid quality is not poor, then the configurator 206 determines (at 1034) if there is an area limitation or a if a dual completion has been installed in the well. If so, the configurator 206 recommends a gas-lift system over an electrical submersible pump (at 1036). However, if there is not an area limitation or if dual completion has not been installed, the configurator 206 determines (at 1038) if high drawdown is required. If high drawdown is required, the configurator, 206 recommends an electrical submersible pump (at 1040). However, if high drawdown is not required, the configurator 206 recommends a gas-lift system over a jet pump (at 1042).

At 1028, if the configurator 206 determines that high water-cut secondary recovery is expected, then the configurator 206 determines (at 1044) if high drawdown is required. If high drawdown is required, then the configurator 206 recommends an electrical submersible pump (at 1046). However, if high drawdown is not required, the configurator 206 determines (at 1048) if the well has an area limitation or if a dual completion has been installed. If an area limitation exists or a dual completion has been installed, an electrical submersible pump is recommended (at 1050).

However, if there is no area limitation or if a dual completion has not been installed, then the configurator 206 recommends a jet pump over an electrical submersible pump (at 1052).

At 1002, if the configurator 206 determines that gas is not available for a gas-lift system, the configurator 206 determines (at 1054) if a low bottom-hole pressure exists (e.g., less than 0.1 psi/ft gradient). If a low bottom-hole pressure exists, then an electrical submersible pump is recommended (at 1056). However, if a low bottom-hole pressure does not exist, then the configurator 206 determines (at 1058) if the well is a deep well (e.g., fluid level greater than 7000 feet). If the well is a deep well, then the configurator 206 determines (at 1060) if the temperature of the well is greater than 400° F. If the temperature is high, the configurator 206 recommends a jet pump (at 1062). However, if the temperature is not greater than 400° F., or if the well is a shallow well, then the configurator 206 determines (at 1064) if there is a dog leg in the wellbore that has an angle greater than 10°. If such a dog leg exists, then the configurator 206 recommends (at 1066) a jet pump. If a dog leg having an angle greater than 10° is not present in the well, then the configurator 206 determines (at 1068) if a high drawdown is required. If high drawdown is required, then the configurator 206 recommends an electrical submersible pump (at 1070). However, if high drawdown is not required, the configurator 206 determines (at 1072) if an area limitation or a dual completion is installed in the wellbore. If so, then an electrical submersible pump is recommended (at 1074). If an area limitation or dual completion is not present in the well, then a jet pump is recommended over an electrical submersible pump (at 1076).

FIG. 13 shows the selection process of an artificial lift system for a subsea well. The configurator 206 determines (at 1102) if gas is available for a gas-lift system. If gas is available, the configurator 206 determines (at 1104) if a long subsea delivery system is present. If a long subsea delivery system is present, then the configurator 206 determines (at 1106) if a low flowing bottom-hole pressure (FBHP) is expected. If a low FBHP is expected, then the configurator 206 recommends (at 1108) an electrical submersible pump with a booster pump at the seabed manifold. If a low FBHP is not expected, then the configurator 206 recommends an electrical submersible pump without the booster pump (at 1110).

At 1104, if the configurator 206 determines that a long subsea delivery system is not present, then the configurator 206 determines (at 1112) if a low FBHP is expected. If so, then the configurator 206 recommends an electrical submersible pump (at 1114). However, if a low FBHP is not expected, then a gas-lift system with a booster pump at the seabed is recommended (at 1116).

At 1102, if it is determined that gas is not available for a gas-lift system, then the configurator 206 determines (at 1118) if a low FBHP is expected. If so, the configurator 206 recommends an electrical submersible pump with a booster pump at the seabed manifold (at 1120). However, if a low FBHP is not expected, the configurator 206 recommends an electrical submersible pump (at 1122) without the booster pump.

The configurator 206 also determines whether flow control devices (such as valves), sensors (such as pressure, temperature, or other sensors) are needed. Also, the completions configurator 206 determines if downhole segmentation is needed (to segment a wellbore into plural parts with sealing elements such as packers.

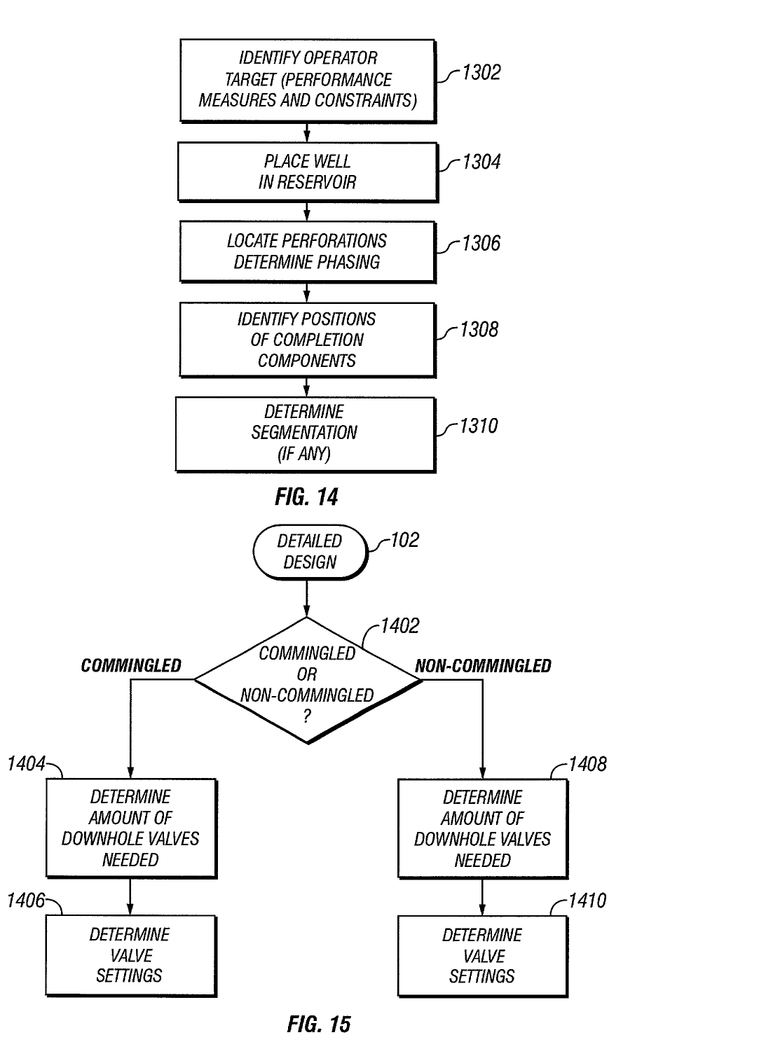

The output from the completions configurator 206 is provided to the completions optimizer 208. The optimizer 208 refines the completion architecture determined by the completions configurator 206. As shown in FIG. 14, the completions optimizer 208 first identifies (at 1302) a target performance measure or constraint set by the well operator. For example, a target performance measure can be cumulative production within a specified time period, or an economic measure such as net present value. A target constraint includes production rate, gas-to-oil ratio, and bottom-hole pressure. The target performance measure and/or constraint are used by the optimizer 208 in refining the completions architecture.

The completions optimizer 208 determines (at 1304) a location in the reservoir to place the well, given the trajectory recommended by the completions configurator 206. Thus, the optimizer 208 determines where in the reservoir to place the vertical, slant, or horizontal well recommended by the configurator 206. The optimizer 208 works with a simulator 216 and economics package 218 (FIG. 3) in determining optimum placement of the well.

The optimizer also locates (at 1306) intervals in the wellbore where perforations are needed. The optimizer 208 also identifies the optimum pattern for the perforations (phased, non-phased). Next, if the configurator 206 recommended the use of intelligent completion components such as flow control devices or sensors, the optimizer 208 identifies (at 1308) the optimum position of such intelligent completion components. Also, the optimizer 208 determines (at 1310) the optimum segmentation for the well, if the configurator 206 suggested the use of segmentation.

The optimizer 208 invokes the simulator 216 to simulate different placements of the well in the reservoir and of completion components in the well to determine if performance measures and restraints can be satisfied. The economics package 218 is also invoked if the performance measure is an economic measure such as net present value. The optimizer 208 may try different positions of the well in the reservoir, different phasing patterns and locations, and different types and positions of completion components, invoking the simulator 216 to determine a change in performance and invoking the economics package 218 to determine the effect of changes on an economic measure.

Once the completion design is generated by the optimizer 208, the output can be displayed to the user in the user interface 214 of the computer system 202. The user interface 214 can include a graphical user interface to graphically depict the completion design.

After performance of the general-level design process, a detailed design process is performed. Referring to FIG. 15, in the detailed design process (102), it is first determined (at 1402) if the given well has a commingled or non-commingled production scenario. If commingled, the number of downhole valves needed is determined (at 1404). The need for downhole valves was determined in the general-design process. Commingled production usually implies more than one downhole valve since flow control in multiple zones may be needed. One exception may be in a situation where natural gas lift (using gas from a contiguous or non-contiguous gas reservoir) is performed, in which case only one valve may be required.

Next, valve settings are determined (at 1406). Valve settings can be based on various considerations. For example, if a well has two zones, and the upper zone has an edge water drive while the lower zone has a bottom water drive, a fixed choke valve in the upper zone and an adjustable valve in the lower zone can be used. Apertures of the adjustable valve are designed to allow production control in the lower reservoir. For example, an optimum design may require a dramatic reduction in aperture from the fully opened (no control) position to the next largest position if control is to be initiated from that position. In such cases, a linear design (in which the valve flow area varies linearly with each setting) may have a limited ability to control the flow.

As another example, a well may have multiple isolated zones, with a top zone having a gas cap and a lower zone having a bottom aquifer. In such a scenario, valves may be used for controlling gas production as well as the production of water.

In the non-commingled scenario, if downhole valves are needed, the number is also determined (at 1408). The position of the valves can be set to segment the wellbore into multiple sections so that the frictional pressure drops can be distributed within the wellbore such that water coning and/or gas cusping is mitigated. Also, the valves can be used so that water encroachment occurs uniformly along the length of the wellbore. Placement of valves in the non-commingled wellbore is also determined (at 1410).

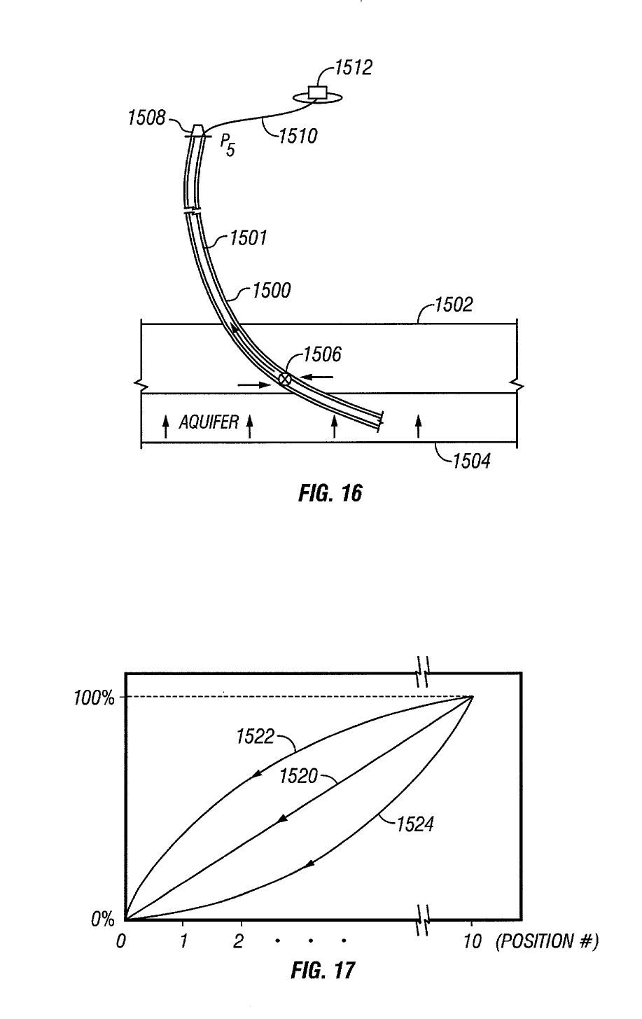

Referring to FIG. 16, an example of completion equipment for use in a non-commingled well 1500 is illustrated. The detailed design phase (102) addresses characteristics of various components of the completion system. The well is associated with the surface facility that includes a flow line 1510 that runs from a wellhead 1508 to a surface station 1512. The surface station 1512 can be a sea vessel if the well is a subsea well. A tubing 1501 extends from the wellhead 508 into the wellbore 1500. The wellbore 1500 extends through a reservoir 1502. Below the reservoir is an aquifer 1504. In this example, production in the reservoir 1502 is driven by water in the aquifer 1504. To control the inflow rate of the hydrocarbon from the reservoir 1502, a valve or other type of flow control device 1506 is attached to the production tubing 1501. The valve 1506 (e.g., a hydraulic valve) can have multiple choke settings to control the flow rate. The valve 1506 can alternatively be a non-discrete valve.

Referring to FIG. 17, the graph illustrates the percentage of flow area of the valve 506 with respect to a plurality of choke positions. In the example of FIG. 17, 10 choke positions are provided in the valve 1506, with position 10 providing a 100% flow area (fully open) and position 0 providing a 0% flow area (fully closed).

Three curves 1520, 1522 and 1524 are illustrated in the graph of FIG. 17. A first curve 1520 shows a linear relationship between the choke positions of the valve 1506 and the flow areas. Thus, with each change in choke position, the flow area varies linearly. It is also possible that the flow area can vary non-linearly with the choke positions, as illustrated with curves 1522 and 1524. Other relationships aside from the curves 1520, 1522, and 1524 can also be specified.

Depending on the characteristics of the reservoir 1502 (e.g., reservoir pressure), the valve profile can be designed to achieve a desired relationship between the different settings of the valve 1506 and corresponding flow areas. For example, one of the curves 1520, 1522, and 1524 (or some other relationship) can be selected.

As noted above, the design of valves attempts to mitigate the problems associated with water coning and gas cusping. One of the problems of water coning or gas cusping is that fluid (water or gas) entering the wellbore from the reservoir causes a reduction in the production of oil. The severity of coning/cusping can be diagnosed by comparing the drawdown at the heel portion of the well to the pressure drops occurring from the toe to the heel of the well. As the wellbore pressure drops become dominant, coning/cusping becomes pronounced. The liquid flow rate target is a parameter that has a significant impact on coning/cusping tendency. Increasing the production rate increases the reservoir drawdown and toe to heel pressure drop simultaneously. Rate change has an even more pronounced effect on frictional losses since wellbore frictional pressure drop is proportional to the square of the velocity. Since horizontal wells are not perfectly horizontal, but are undulating due to geosteering constraints during drilling, greater frictional pressure drops also result from the undulations.

Downhole flow control valves can be used to delay or prevent coning/cusping tendency or to control production after gas or water has broken through. Location of the valves is important in terms of the equilibration of the drawdown at each inflow section. By equilibrating the inflow, the coning/cusping tendency can be mitigated. Electrical valves provide for greater resolution of valve openings and closures, while hydraulic valves have a discrete number of settings from fully open to fully closed. Although electrical valves provide more flexibility than hydraulic valves, electrical valves are also generally more expensive.

The number and positioning of valves can be modeled by using numerical simulation. Thus, in one example embodiment, the well can be divided into multiple segments, so that the well is represented as a series of segments arranged in sequence along the wellbore. A multilateral well can be represented as a series of segments along its main stem, with each lateral branch including a series of segments. Each segment is represented as a node and a flow path. Each node lies at a specific depth in the wellbore, and is associated with a nodal pressure. Each segment also has a specific length, diameter, roughness, area, and volume. The volume is used for wellbore storage calculations, while the other attributes are properties of its flow path and are used in the friction and acceleration pressure loss calculations. Using such a representation of a wellbore, various combinations of valve locations and numbers of valves can be considered by performing simulations using the simulator tool.

In the multi-segment well model, each valve can be modeled as a “labyrinth” inflow control device. This type of device is used to control the inflow profile along a horizontal well or branch by imposing an additional pressure drop between the annulus and the tubing. The device is placed around a section of the tubing and diverts the fluid inflowing from the adjacent part of the formation into a series of small channels before it enters the tubing. The additional pressure drop that it imposes depends upon the length of the flow path through the system of channels, which is adjustable. A series of labyrinth devices with different channel settings can be placed along the length of a horizontal well or branch, with the aim, for example, of constraining the flow and thus reducing the variation of the drawdown along the horizontal well or branch. A detailed description of one example of a design process for wellbores is described in U.S. Provisional Application Serial No. 60/237,083, filed Sep. 28, 2000, which is hereby incorporated by reference. Another study further indicates that the use of instrumentation (e.g., valves) is effective in controlling water coning. This study is discussed in U.S. Provisional Application Serial No. 60/237,084, filed Sep. 28, 2000, which is hereby incorporated by reference.

Yet another study concluded that high friction loss wells (e.g., long horizontal wells, wells having smaller completion systems, wells with high permeability reservoirs) are suitable candidates for instrumentation to mitigate the effects of water coning and gas cusping. This study is discussed in U.S. Provisional Application Serial No. 60/236,125, filed Sep. 28, 2000, which is hereby incorporated by reference. A further study indicates that instrumentation used to mitigate effects of gas cusping can allow production to be accelerated without decreasing gas breakthrough time. This further study is discussed in U.S. Provisional Application Serial No. 60/236,905, filed Sep. 28, 2000, which is hereby incorporated by reference.

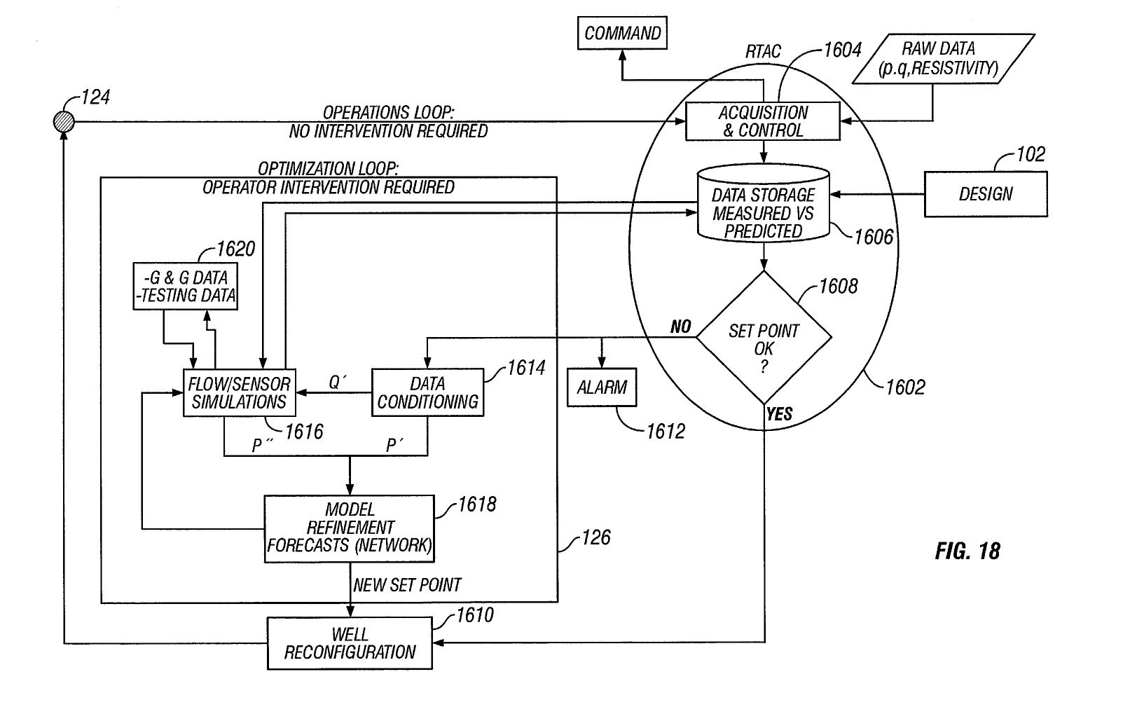

Referring to FIG. 18, the operation phase (104 in FIG. 2) of the well planning and design procedure described herein is illustrated. In one embodiment, the operation phase is controlled by a control system 1602, which includes an acquisition and control module 1604 and a data storage module 1606. The control system 1602 acquires raw data that is measured by downhole sensors, with such data including pressure, flow rate, resistivity, temperature, and so forth. Based on the acquired information, the control system determines (at 1608) if a set point of the conceptual model developed during the detailed design stage (102) can be met by the completion design. If the set point can be met, then the control system 1602 sends commands (at 1610) to perform reconfiguration (if necessary) of the completion system in the well to bring the operation in line with the set point provided by the conceptual model. Control then proceeds back to the initial stage of acquiring measured data from the well. This is the operation loop (124).

However, if the control system 1602 determines (at 1608) that the set point provided by the conceptual model cannot be met, then the control system 1602 generates an alarm (at 1612) and proceeds to the optimization loop (126). Data conditioning is first performed (at 1614) on the measured data, which includes pressure (P) and fluid rate (Q) in one example. Data conditioning refers to filtering or other corrections of data measured by sensors to remove the effects of noise or other anomalous sensor behavior (e.g. ‘drift’). The filtered flow rate (Q′) is provided to a simulator, where simulation is performed (at 1616) based on the measured flow rate. Filtered pressure data (P′) is provided to a process which performs model refinement (at 1618). Using test data 1620, the flow simulation (at 1616) generates a simulated pressure value (P″) based on the current model. The simulated pressure value (P″) is provided to the model refinement block (1618). Based on a comparison of the measured pressure P′ and simulated pressure P″, the model refinement block (1618) generates a refined model that is fed to the simulation 1616. This loop continues until the model has been modified to cause P′ and P″ to match. When that occurs, the refined model is fed to the control system 1602 to perform reconfiguration of the well completion system.

Instructions of the various software routines or modules discussed herein (such as the completions configurator 206 and completions optimizer 208) are stored on one or more storage devices in a system and loaded for execution on a control unit or processor. The control unit or processor includes microprocessors, microcontrollers, processor modules or subsystems (including one or more microprocessors or microcontrollers), or other control or computing devices. As used here, a “controller” or “module” refers to hardware, software, or a combination thereof. A “controller” or “module” can refer to a single component or to plural components (whether software, hardware, or a combination thereof).

Data and instructions (of the various software modules and layers) are stored in a storage device, which can be implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software modules or layers are loaded or transported to the system in one of many different ways. For example, code segments including instructions stored on floppy disks, CD or DVD media, a hard disk, or transported through a network interface card, modem, or other interface device are loaded into the system and executed as corresponding software modules or layers. In the loading or transport process, data signals that are embodied in carrier waves (transmitted over telephone lines, network lines, wireless links, cables, and the like) communicate the code segments, including instructions, to the system. Such carrier waves are in the form of electrical, optical, acoustical, electromagnetic, or other types of signals.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of determining a configuration of a well, comprising:
receiving, at a first module executable in a system, input data relating to characteristics of a reservoir and a well surface arrangement; and
selecting, by the first module based on the input data, a trajectory of a wellbore in the well, a type of interface between the reservoir and the wellbore, and completion equipment for installation in the wellbore.

2. The method of claim 1, further comprising displaying an output representing the selected wellbore trajectory, type of interface, and completion equipment in a user interface of the system.

3. The method of claim 1, further comprising determining, by the first module based on the input data, if the well is to be a multilateral well.

4. The method of claim 3, wherein determining if the well is to be a multilateral well comprises determining a type of multilateral well based on one or more of the following factors: the reservoir is mature, flooded, or depleted; a platform has slot constraints; the well has a high-pressure, high-temperature region; the well has a naturally fractured reservoir; the well has a reservoir with heavy oil; the reservoir is a layered reservoir; the reservoir permeability; and the thickness of the reservoir.

5. The method of claim 1, wherein receiving input data relating to the characteristics of the reservoir comprises receiving data relating to one or more of the following: a geometry of the reservoir; if the reservoir is fractured; if the reservoir contains heavy oil; a permeability of the reservoir; a vertical permeability to horizontal permeability ratio in the reservoir; a variation of the permeability in the reservoir; and a drive mechanism of the reservoir.

6. The method of claim 5, wherein receiving input data relating to the well surface arrangement comprises receiving an indication of whether the well surface arrangement is a land well, an offshore well with a surface platform, or a subsea well.

7. The method of claim 6, wherein selecting the well trajectory comprises selecting one of a vertical well, a slant well, and a horizontal well.

8. The method of claim 5, wherein selecting the type of interface between the reservoir and wellbore comprises selecting one of an open hole completion, a cased hole completion, and a slotted liner completion.

9. The method of claim 8, further comprising receiving input data relating to whether a formation containing the reservoir is a sandstone formation or a carbonate formation,
wherein selecting the type of interface is further based on receiving the input data relating to the formation.

10. The method of claim 1, wherein selecting the completion equipment comprises selecting an arrangement of a lower completion in the well.

11. The method of claim 10, wherein selecting the arrangement of the lower completion comprises selecting a type of sand control arrangement.

12. The method of claim 1, wherein selecting the completion equipment comprises selecting a type of artificial lift system.

13. The method of claim 1, wherein selecting the completion equipment comprises selecting at least one of a flow control device and a sensor.

14. The method of claim 1, further comprising refining a proposed configuration generated by the first module, the proposed configuration comprising the well trajectory, the reservoir-wellbore interface, and the completion equipment.

15. The method of claim 14, wherein refining the proposed configuration comprises one or more of the following: determining placement of the well with the proposed well trajectory in the reservoir; determining placement of perforations; and determining a position of completion equipment.

16. The method of claim 15, wherein refining the proposed configuration is based on a predefined performance measure.

17. The method of claim 16, wherein refining the proposed configuration is based on a constraint selected from the group consisting of a target production rate, a target gas-to-oil ratio, and a target bottom-hole pressure.

18. The method of claim 16, wherein refining the proposed configuration comprises invoking a simulator to assess performance of the proposed configuration.

19. The method of claim 18, wherein refining the proposed configuration comprises invoking an economics tool to determine effect of the proposed configuration on a predefined economic measure.

20. An article comprising at least one storage medium containing instructions for determining a configuration of a well, the instructions when executed causing a system to:
receive input data relating to characteristics of a reservoir and a well surface arrangement; and
generate a proposed configuration of the well using a rule-based analysis, the proposed configuration including a trajectory of a wellbore in the well, a type of interface between the reservoir and the wellbore, and completion equipment for installation in the wellbore based on the input data.

21. The article of claim 20, wherein the instructions when executed cause the system to further determine, based on the input data, if the well is to be a multilateral well.

22. The article of claim 20, wherein the instructions when executed cause the system to receive the input data relating to the characteristics of the reservoir by receiving data relating to one or more of the following: a geometry of the reservoir; if the reservoir is fractured; if the reservoir contains heavy oil; a permeability of the reservoir; a vertical permeability to horizontal permeability ratio in the reservoir; a variation of the permeability in the reservoir; and a drive mechanism of the reservoir.

23. The article of claim 22, wherein the instructions when executed cause the system to receive input data relating to the well surface arrangement by receiving an indication of whether the well surface arrangement is a land well, an offshore well with a surface platform, or a subsea well.

24. The article of claim 20, wherein the instructions when executed cause the system to generate the proposed configuration by selecting an arrangement of a lower completion in the well.

25. The article of claim 24, wherein the instructions when executed cause the system to generate the proposed configuration by further selecting a type of sand control arrangement.

26. The article of claim 20, wherein the instructions when executed cause the system to generate the proposed configuration by selecting a type of artificial lift system.

27. The article of claim 20, wherein the instructions when executed cause the system to generate the proposed configuration by selecting at least one of a flow control device and a sensor.

28. The article of claim 20, wherein the instructions when executed cause the system to further refine the proposed configuration.

29. The article of claim 28, wherein the instructions when executed cause the system to refine the proposed configuration by performing one or more of the following: identify a placement of the well with the proposed well trajectory in the reservoir; identify a placement of perforations; and identify a position of completion equipment.

30. The article of claim 29, wherein the instructions when executed cause the system to refine the proposed configuration based on a predefined performance measure.

31. The article of claim 30, wherein the instructions when executed cause the system to further invoke a simulator to assess performance of the proposed configuration in refining the proposed configuration.

32. A system comprising:
a processor; and
one or more modules executable on the processor to receive input data relating to characteristics of a reservoir and a well surface arrangement,
the one or more modules executable to further generate a proposed configuration of the well, the proposed configuration including a trajectory of a wellbore in the well, a type of interface between the reservoir and the wellbore, and completion equipment for installation in the wellbore based on the input data.

33. The system of claim 32, further comprising an optimizer module executable on the processor to refine the proposed configuration based on a performance measure.

34. The system of claim 33, further comprising a simulator executable on the processor, the optimizer module to invoke the simulator to determine effect of the proposed configuration on the performance measure.

35. The system of claim 32, further comprising a storage containing case histories of installed completions in respective wells, the one or more modules to access the case histories in generating the proposed configuration.
